(19) United States
(12) Patent Application Publication
(10) Pub. No.: US 2026/0229030 A1
(43) Pub. Date: Aug. 6, 2026

(54) ASSISTED SEARCHING IN A PHYSICAL ENVIRONMENT

(71) Applicant: QUALCOMM Incorporated, San Diego, CA (US)

(72) Inventors: Robert TARTZ, Imperial Beach, CA (US); Gang DING, San Diego, CA (US); Brian VOGELSANG, San Diego, CA (US)

(21) Appl. No.: 19/396,177

(22) Filed: Nov. 20, 2025

Related U.S. Application Data
(60) Provisional application No. 63/753,396, filed on Feb. 3, 2025.

(51) Int. Cl. G06V 20/20; G06T 19/00

(52) U.S. Cl. CPC G06V 20/20; G06T 19/006

(57) ABSTRACT

Systems and techniques are described herein for extended reality (XR). For instance, a method for extended reality is provided. The method may include capturing an image of a physical environment using a camera of an extended-reality (XR) device in the physical environment; transmitting the image to a remote computing device; receiving, from the remote computing device, an indication of an object in the physical environment; receiving, from a local device, information regarding the object; and displaying the information regarding the object at a display of the XR device.

### CROSS-REFERENCE TO RELATED APPLICATIONS

This application claims the benefit of U.S. Provisional Application No. 63/753,396, filed Feb. 3, 2025, which is incorporated herein by reference in its entirety.

### TECHNICAL FIELD

The present disclosure generally relates to searching for objects. For example, aspects of the present disclosure include systems and techniques for assisted searching for objects in a physical environment.

### BACKGROUND

Extended reality (XR) technologies can be used to present virtual content to users, and/or can combine real environments from the physical world and virtual environments to provide users with XR experiences. The term XR can encompass virtual reality (VR), augmented reality (AR), mixed reality (MR), and the like. XR systems can allow users to experience XR environments by overlaying virtual content onto a user's view of a real-world environment.

For example, an XR head-mounted device (HMD) may include a display that allows a user to view the user's real-world environment through a display of the HMD (e.g., a transparent display). The XR HMD may display virtual content at the display in the user's field of view overlaying the user's view of their real-world environment. Such an implementation may be referred to as “see-through” XR. As another example, an XR HMD may include a scene-facing camera that may capture images of the user's real-world environment. The XR HMD may modify or augment the images (e.g., adding virtual content) and display the modified images to the user. Such an implementation may be referred to as “pass through” XR or as “video see through (VST).” The user can generally change their view of the environment interactively, for example by tilting or moving the XR HMD.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for extended reality. According to at least one example, a method is provided for extended reality. The method includes: capturing an image of a physical environment using a camera of an extended-reality (XR) device in the physical environment; transmitting the image to a remote computing device; receiving, from the remote computing device, an indication of an object in the physical environment; receiving, from a local device, information regarding the object; and displaying the information regarding the object at a display of the XR device.

In another example, an apparatus for extended reality is provided that includes at least one memory and at least one processor (e.g., configured in circuitry) coupled to the at least one memory. The at least one processor configured to: capture an image of a physical environment using a camera of an extended-reality (XR) device in the physical environment; transmit the image to a remote computing device; receive, from the remote computing device, an indication of an object in the physical environment; receive, from a local device, information regarding the object; and display the information regarding the object at a display of the XR device.

In another example, a non-transitory computer-readable medium is provided that has stored thereon instructions that, when executed by one or more processors, cause the one or more processors to: capture an image of a physical environment using a camera of an extended-reality (XR) device in the physical environment; transmit the image to a remote computing device; receive, from the remote computing device, an indication of an object in the physical environment; receive, from a local device, information regarding the object; and display the information regarding the object at a display of the XR device.

In another example, an apparatus for extended reality is provided. The apparatus includes: means for capturing an image of a physical environment using a camera of an extended-reality (XR) device in the physical environment; means for transmitting the image to a remote computing device; means for receiving, from the remote computing device, an indication of an object in the physical environment; means for receiving, from a local device, information regarding the object; and means for displaying the information regarding the object at a display of the XR device.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example extended-reality (XR) system, according to aspects of the disclosure;

FIG. 2 is a diagram illustrating another example extended reality (XR) system, according to aspects of the disclosure;

FIG. 3 is a block diagram illustrating an architecture of an example extended reality (XR) system, in accordance with some aspects of the disclosure;

FIG. 4 is a block diagram illustrating a Radio-Frequency Identification (RFID) tag, according to various aspects of the present disclosure;

FIG. 5 is a block diagram illustrating an example RFID reader, according to various aspects of the present disclosure;

FIG. 6 is a diagram illustrating an example RFID system that includes an RFID reader (e.g., energizer) and an RFID tag;

FIG. 7 is a block diagram of an example system for assisted searching in a physical environment, according to various aspects of the present disclosure;

FIG. 8 is a block diagram illustrating various operations that may be performed by system, according to various aspects of the present disclosure;

FIG. 9 is a block diagram illustrating various operations that may be performed by system, according to various aspects of the present disclosure;

FIG. 10 is a diagram illustrating an example scenario to illustrate various operations that may be performed according to various aspects of the present disclosure;

FIG. 11 is a diagram illustrating an example scenario to illustrate various operations that may be performed according to various aspects of the present disclosure;

FIG. 12A and FIG. 12B include example images illustrating the scenario of FIG. 11;

FIG. 13A is a flow diagram illustrating an example process for assisted searching, in accordance with aspects of the present disclosure;

FIG. 13B is a flow diagram illustrating an example process for assisted searching, in accordance with aspects of the present disclosure;

FIG. 14 is a block diagram illustrating an example of a deep learning neural network that can be used to perform various tasks, according to some aspects of the disclosed technology;

FIG. 15 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Extended Reality (XR) is an umbrella term that encompasses a range of immersive technologies, integrating real and virtual environments along with human-machine interactions facilitated by computer technology and wearable devices. XR includes various forms such as Augmented Reality (AR), Mixed Reality (MR), and Virtual Reality (VR), covering the continuum between these distinct yet interconnected experiences.

Augmented Reality (AR) overlays digital information or objects onto the physical world, enhancing the user's perception of reality without fully immersing them in a digital environment. In AR, there is an association between the digital objects and the physical elements, but they don't interact. Mixed Reality (MR) merges real and virtual worlds to create new environments where physical and digital objects co-exist and interact in real-time. Virtual Reality (VR) fully immerses users in a simulated digital environment, isolating them from the physical world.

XR technologies are employed across a wide range of applications and industries, including entertainment, healthcare, education, marketing, engineering, manufacturing and emergency response. These technologies provide revolutionary experiences by leveraging multisensory outputs and advanced sensing, communication and computing capabilities.

The development and deployment of XR technologies are significantly influenced by advancements in communication network capabilities, particularly with the advent of 5G and future 6G networks. These networks offer the low latency, high bandwidth, and reliable connectivity required to support the demanding data communication needs of XR applications. Additionally, enabling XR services based on public wide area networks raise the need for the development of new network architectures, quality of service (QoS) frameworks, and media processing functions to ensure seamless and high-quality user experiences.

Extended Reality (XR) encompasses a wide range of use cases that span various industries, each leveraging the immersive capabilities enabled by Augmented Reality (AR), Virtual Reality (VR), and Mixed Reality (MR). These use cases are characterized by their unique requirements in terms of communication, interactivity, and real-time processing, relying on advanced network and device capabilities to deliver optimal user experiences.

One example of a use case of XR is in the domain of entertainment, where XR technologies are utilized to create immersive gaming and multimedia experiences such as virtual concerts, sports events and interactive movies. In gaming, XR allows for a more immersive and therefore more engaging experience by integrating virtual elements into the physical environment or by fully immersing the player in a virtual world. Virtual concerts, sports events and interactive movies enable users to participate in live events from remote locations, and experience movies with active participation in the story line providing a sense of presence and interaction that surpasses traditional media formats.

In the field of education and training, XR applications facilitate immersive learning environments that enhance the educational experience. For instance, medical students can engage in virtual dissections or simulated surgeries, while engineering students can interact with complex machinery in a virtual space. These applications provide hands-on learning opportunities without the risks or costs associated with physical training environments. Similarly, in professional training, XR applications can simulate real-world scenarios, such as emergency response drills or industrial operations, allowing trainees to practice and refine their skills in a controlled setting enabling both repeatability and diversity in the range of experiences.

Healthcare is another area where XR technologies are making substantial impact. XR applications in healthcare include virtual consultations, where patients and healthcare providers can interact in a virtual setting, and augmented surgeries, where surgeons use AR to overlay critical information onto the patient's body during procedures. These applications improve the efficacy and efficiency of medical treatments and expand access to healthcare services, particularly in remote or underserved areas.

In the industrial and manufacturing sectors, XR technologies are used to enhance productivity and safety. Workers can use AR glasses to receive real-time instructions and information overlays while performing complex tasks, reducing errors and improving efficiency. Additionally, XR applications can be employed for remote maintenance and troubleshooting, allowing experts to guide on-site personnel through repairs and diagnostics without the need for experts to be physical present.

Another emerging use case of XR technologies is in the development of the Metaverse, a collective virtual shared space that integrates physical and virtual realities. The Metaverse enables users to interact with digital environments and other users in real-time, supporting activities such as virtual meetings, social interactions, and collaborative workspaces. This concept extends the boundaries of traditional virtual environments, creating a seamless blend of the physical and digital worlds.

Furthermore, XR technologies are being integrated into marketing and retail, where they provide interactive and personalized shopping experiences. Consumers can use AR to visualize products in their own environment before making a purchase, or they can explore virtual showrooms and stores. These applications can enhance customer engagement and satisfaction by offering a more immersive, engaging and informative shopping experience.

XR applications in the entertainment sector leverage the immersive capabilities of VR, MR, and AR to transform traditional entertainment experiences, offering advanced, novel means of interactivity, engagement, and realism. The integration of XR technologies into entertainment encompasses several key areas, including gaming, virtual concerts, interactive media, and immersive storytelling.

In the domain of gaming, XR has revolutionized the way users interact with digital content by providing fully immersive environments that respond to user movements and actions in real-time. VR gaming, for example, employs headsets equipped with stereoscopic displays (enabling depth perception), spatial audio (providing a realistic sound field), and motion-tracking sensors to create a simulated environment that isolates the user from the physical world, thereby enhancing the sense of presence and engagement in the virtual game environment. Augmented and Mixed Reality gaming, on the other hand, overlay digital elements onto the physical environment, allowing users to interact with virtual objects within their real-world surroundings. This blend of virtual and physical elements enhances the gaming experience by integrating it into the user's daily environment.

Virtual concerts and live events represent other significant applications of XR technologies in the entertainment sector. These experiences enable users to attend live performances from remote locations, providing a sense of presence and interaction that surpasses traditional multimedia broadcast methods. Through VR, users can experience concerts as if they were physically present, with the ability to look around the venue, interact with other attendees, and enjoy a front-row view from the comfort of their homes. This not only broadens access to live events but also offers new revenue streams for artists and event organizers by reaching a global audience.

Interactive media and immersive storytelling are also transformed through the use of XR technologies. These applications allow users to become active participants in the narrative, influencing the storyline through their interactions. By employing VR and AR, content creators can craft experiences where users explore virtual worlds, solve puzzles, and interact with characters in ways exceeding traditional media offerings' capabilities. This level of interactivity and immersion enhances user engagement and provides a deeper emotional connection to the content.

Furthermore, XR technologies are being utilized in theme parks and location-based entertainment services to create immersive attractions that combine physical and digital elements. These attractions often use VR headsets, AR displays, and haptic feedback devices to deliver multi-sensory experiences that transport visitors to fantastical worlds or simulate thrilling adventures. The integration of XR in these settings enhances the overall experience by making it more interactive, realistic and personalized.

The deployment of XR technologies in entertainment also extends to social networking, where virtual environments enable users to interact with friends and family in shared digital spaces. These virtual social platforms allow for activities such as watching movies together, playing games, or simply socializing in a virtual setting, thereby bridging the gap between physical distance and social interaction.

XR technologies (including VR, MR, and/or AR) provide for transformative applications in the fields of education and training. XR technologies enhance traditional learning and training methodologies by providing immersive, interactive, and experiential environments that can foster deeper understanding and retention of information.

In educational settings, XR technologies offer the ability to create immersive learning environments that can bring abstract concepts to life. For example, AR technologies can be utilized to overlay digital information onto physical textbooks, and experimental setups allowing students to visualize complex scientific phenomena or historical events in three dimensions. Similarly, VR can enable transporting students to virtual environments where they can explore historical sites, conduct virtual dissections, or engage in simulated scientific experiments. These immersive experiences not only make learning more engaging and fun, but also enable students to grasp difficult concepts more effectively by visualizing and interacting with the subject matter in a controlled, virtual space.

The use of XR technologies in training applications spans various industries, providing realistic simulations that enhance skill acquisition and proficiency. In the medical field, for instance, VR simulations allow medical students and professionals to practice surgical procedures in a risk-free environment. These simulations can replicate a wide range of scenarios, from common operations to rare and complex cases, enabling trainees to hone their skills and improve their decision-making abilities without the consequences of real-life errors. Similarly, AR can assist surgeons during actual procedures by overlaying critical information, such as patient vitals or anatomical guides, directly onto their field of view, thereby enhancing precision and reducing the likelihood of mistakes.

In the realm of industrial training, XR technologies are employed to simulate complex machinery operations and maintenance procedures. Trainees can interact with virtual models of real equipment, learning to assemble, disassemble, and troubleshoot components in a highly detailed and interactive manner. This type of training is particularly valuable in high-risk industries, such as aerospace or nuclear power generation, where hands-on experience with actual equipment may be limited due to safety concerns or high costs. XR simulations, here again, provide a safe and cost-effective alternative, allowing workers to gain crucial practical experience and build confidence before handling real machinery.

Furthermore, XR technologies facilitate remote training and collaboration, breaking down geographical barriers and enabling access to expert instruction regardless of location. Through VR, trainees can participate in virtual classrooms or workshops, interacting with instructors and peers in real-time. This capability is especially beneficial in scenarios where access to specialized training facilities or instructors is limited. Additionally, AR can be used for remote assistance, where experts can guide on-site personnel through complex tasks by providing real-time visual instructions and feedback, thereby improving efficiency and reducing the need for physical travel.

The integration of XR technologies in education and training also extends to the development of soft skills, such as communication, teamwork, and leadership. VR simulations can generate realistic social scenarios where individuals practice and refine these skills in a controlled environment. For example, trainees can engage in virtual role-playing exercises that mimic workplace interactions, customer service situations, or conflict resolution scenarios. These simulations provide valuable opportunities for experiential learning, allowing individuals to receive immediate feedback and consequently improve their performance in real-world situations.

The Metaverse, an evolving paradigm for the next-generation Internet, aims to provide three-dimensional (3D) immersive experiences and self-sustaining i.e., decentralized, independent, and enabled by a closed economic loop, virtual shared spaces by utilizing a wide range of relevant technologies. Extended Reality (XR), encompassing Virtual Reality (VR), Mixed Reality (MR), and Augmented Reality (AR), is a crucial enabler of the Metaverse. This integration facilitates the creation of a virtual universe that is interactive, social, and persistent, offering novel, captivating experiences through multisensory engagement.

The Metaverse leverages XR technologies to create immersive environments where users interact with software applications and other users as avatars within a 3D virtual world. These interactions are enhanced by the capabilities of VR, which immerses users in fully simulated digital environments, and AR, which overlays digital information or objects onto the physical world. The combination of these technologies provides a seamless blend of the virtual and physical realms, enabling users to experience a unique existence in virtual space akin to the real world.

An example of an application of XR technologies in the Metaverse is in the realm of social interactions. Users can engage in shared virtual spaces where they can socialize, collaborate, and participate in various activities. These virtual environments are designed to be highly interactive, allowing users to communicate through avatars, and explore digital landscapes together. The persistent nature of the Metaverse ensures that these interactions and environments continue to exist and evolve even when users are not actively engaged, creating a continuous and dynamic virtual world.

The Metaverse also extends to various industrial applications, where XR technologies facilitate remote collaboration and training. For example, in the field of autonomous vehicles, AR technology can be used to create immersive environments for remote assistance systems. These systems leverage 360° live video streaming and mobile edge-enabled distributed computing paradigms to provide real-time support and decision-making capabilities in emergency situations. The integration of XR in such applications enhances the effectiveness of remote operations by providing a more intuitive and immersive interface for users.

In the educational sector, the Metaverse utilizes XR to create interactive and immersive learning experiences. By incorporating AR and VR, educators can develop virtual classrooms and training simulations that provide hands-on learning opportunities in a safe and controlled environment. These virtual environments can replicate real-world scenarios, allowing students to practice skills and gain knowledge in a more engaging and effective manner. The use of XR in education not only enhances the learning experience but also enables access to specialized training and resources regardless of geographical constraints.

Furthermore, the Metaverse supports the development of virtual economies, where users can engage in commerce and trade within the virtual world. XR technologies facilitate the creation of digital marketplaces, where users can buy, sell, and trade virtual goods and services. These virtual economies are supported by the underlying infrastructure of the Metaverse, which includes blockchain technology for secure transactions and digital asset management. The integration of XR in these virtual economies enables a more immersive and interactive experience for users, fostering economic activity and innovation within the virtual world.

XR technologies have several technical target metrics to provide optimal performance and user experience. These key metrics are determined by the specific use cases and applications of XR, which include but are not limited to education, training, gaming, multimedia, navigation, and communication. The following describes some important target metrics for XR use cases and applications:
XR applications perform best with low latency and high reliability to deliver seamless and immersive experiences. For instance, VR applications often perform best with latencies between 5 to 20 milliseconds, while AR applications can tolerate latencies up to 50 milliseconds. The reliability of frame delivery should be high, typically around 99%, to prevent or decrease the occurrence of disruptions in the user experience.

The bandwidth metrics for XR applications vary based on the complexity and type of content being delivered. VR applications generally use downlink bitrates ranging from 30 to 100 Mbps, whereas AR applications may need bitrates between 2 to 60 Mbps Cloud gaming, another significant XR use case, use downlink bitrates of 8 to 30 Mbps and uplink bitrates of approximately 0.3 Mbps.

The processing demands of XR applications are substantial, often involving the offloading of computational tasks to edge or cloud servers. This offloading may be important for lightweight and cost-efficient head-mounted displays (HMDs), which benefit from reduced local processing requirements. The use of edge computing may be important for meeting the stringent latency and bandwidth target metrics of XR applications.

XR applications may impose significant demands on network infrastructure. The deployment of fifth generation (5G) networks, with their enhanced capabilities in terms of data rates and latency, may be useful in supporting the network target metrics of XR applications. For example, 5G networks may support bitrates of tens of Mbps and latencies of 10-20 milliseconds to achieve high reliability for XR applications. The development of 6G wireless systems is anticipated to further enhance these capabilities, enabling even more advanced XR applications.

The capabilities of XR devices, including HMDs, AR glasses, and other wearables, play a role in determining the performance of XR applications. To achieve desired performance, XR devices should support high-resolution displays, accurate motion tracking, and robust connectivity to deliver high-quality XR experiences. Additionally, the form factor and ergonomics of these devices are important to user comfort and prolonged use.

Ensuring a high Quality of Experience (QoE) for users is important for the success of XR applications. This involves maintaining consistent frame rates, minimizing motion sickness, and providing intuitive and responsive interactions. The QoE is influenced by various factors, including network performance, device capabilities, and the effectiveness of computational offloading.

The development and adoption of standardized interfaces, protocols, and formats are essential for the interoperability of XR applications across different devices and platforms. Standardization efforts focus on defining high-level call flows, parameter exchanges, and technical requirements to ensure consistent and high-quality XR experiences. This includes the identification of potential standardization areas and their timelines to support the evolving XR ecosystem.

XR applications (e.g., VR applications, AR applications, and/or MR applications) demand substantial data rates to deliver high-quality, immersive experiences. These requirements are driven by the need to support complex visual and interactive elements in real-time, ensuring seamless and immersive user experiences.

For high-resolution displays, XR applications necessitate significant data rates. For instance, VR headsets like the HTC Vive Cosmos Elite, which feature a resolution of 1440×1700 per eye at a refresh rate of 90 Hz, require a data rate of approximately 10.6 Gbps without compression. This calculation is derived from the formula: resolution (1440×1700)×color depth (3 bytes)×number of eyes (2)×refresh rate (90 Hz). Although standard video compression techniques can reduce this requirement significantly, the demand for high data rates remains substantial.

The bandwidth requirements for XR applications vary depending on the specific use case. VR applications typically necessitate higher downlink bit rates compared to AR and cloud gaming due to the need to support retinal resolution and low-latency encoding. For example, VR applications may require downlink bit rates ranging from 30 to 100 Mbps, while AR applications may need downlink bit rates between 2 to 60 Mbps. Cloud gaming, another XR use case, requires downlink bit rates of 8 to 30 Mbps.

Ultimate XR applications, which aim to provide the highest quality and most immersive experiences, have even more stringent data rate requirements. These applications may require uncompressed data rates up to 2.3 Tbps with latency lower than 1 ms to achieve the desired level of immersion and responsiveness. Such high data rates are currently beyond the capabilities of existing 5G networks and necessitate advancements in wireless technologies, such as the development of 6G systems.

Holographic imaging, a potential future application of XR, further escalates data rate requirements. The transmission of holographic images, which need to account for variations in tilts, angles, and observer positions, may require transmission rates as high as 4.32 Tbps. This requirement arises from the need to transmit data from multiple viewpoints to ensure seamless content delivery and user experience. Such high data rates necessitate additional synchronization and coordination of transmissions.

The deployment of advanced network infrastructure is essential to meet the high data rate requirements of XR applications. While 5G networks provide significant improvements in data rates and latency, they are still insufficient for ultimate XR applications. The envisioned 6G wireless system, with a peak data rate of 1 Tbps and an experienced data rate of 1.0 Gbps, is anticipated to support the high-quality requirements of future XR applications. Additionally, next-generation Wi-Fi systems, such as 1202.11be and 1202.11ay, which offer data rates of around 46 Gbps and 100 Gbps respectively, will play a crucial role in supporting XR applications.

To manage the high data rate requirements, XR applications often rely on advanced data compression techniques. For instance, the use of H.266 (Versatile Video Coding) can significantly reduce the data rates needed for high-quality video transmission. However, even with compression, the data rates required for ultimate XR applications remain substantial, necessitating robust network infrastructure and efficient data management strategies.

XR applications may also necessitate stringent low latency requirements to ensure immersive and responsive user experiences. The necessity for low latency in XR applications is driven by the need to synchronize virtual content with the real world in real-time, thereby preventing motion sickness and maintaining a seamless interaction between the user and the virtual environment.

The latency requirements for XR applications are categorized based on the type of interaction and the level of immersion involved. For ultra-low latency applications, such as high-interactive VR and certain AR scenarios, the roundtrip interaction delay must be at most 50 milliseconds. This is essential to prevent perceptible lag that can disrupt the user experience and cause discomfort. In contrast, low-latency applications, which may involve less critical interactions, can tolerate roundtrip interaction delays of up to 100 milliseconds.

AR and MR applications, in particular, mix virtual content with the real environment, necessitating ultra-low latency for video rendering to respond to dynamic changes in the real world. For instance, if a user is observing a moving vehicle through an AR application, the system must render the virtual content in synchrony with the real-world movement to maintain realism and prevent disorientation. MR applications, which involve more complex interactions with virtual content, impose even stricter latency requirements than AR, as they must handle dynamic interactions with both virtual and real elements simultaneously.

For VR applications, the latency tolerance varies depending on the level of interactivity. High-interactive VR applications, such as gaming, demand ultra-low latency to ensure that the virtual environment responds instantaneously to the user's movements, thereby maintaining immersion. Conversely, low-interactive VR applications, such as virtual movie theaters, can tolerate higher latency since the user's interaction with the virtual environment is minimal.

The concept of motion-to-photon latency is critical in XR applications, particularly in VR. This latency represents the time taken from the user's physical movement to the corresponding update in the visual display. For high-interactive VR applications, motion-to-photon latency must be kept below 20 milliseconds to prevent motion sickness and maintain a coherent virtual experience Technologies such as asynchronous time warp can help mitigate some latency by adjusting the rendered content to compensate for changes in the user's pose between the time of rendering and display.

The deployment of advanced network infrastructure, including 5G and future 6G systems, is essential to meet the low latency requirements of XR applications. 5G networks have significantly improved data rates and reduced latency, but the ultimate goal of achieving latencies lower than 1 millisecond for the most demanding XR applications remains a challenge. Moreover, techniques such as edge computing and content caching near the user can further reduce latency by minimizing the distance that data must travel.

The low power consumption requirement for Extended Reality (XR) use cases and applications is driven by the need to enhance the Quality of Experience (QoE) while ensuring the practicality and usability of XR devices. XR devices, which encompass Augmented Reality (AR), Mixed Reality (MR), and Virtual Reality (VR) headsets, are inherently wearable and thus must be lightweight and capable of prolonged operation without frequent recharging.

A critical aspect of XR devices is their power consumption, which directly impacts battery life and user comfort. High power consumption not only depletes the battery rapidly but also generates heat, adversely affecting the user experience. Current XR devices typically support only two to three hours of operation, which is insufficient for persistent applications. This limitation is exacerbated by the weight of these devices, which is around 500 grams, significantly higher than standard optical glasses that weigh approximately 20 grams.

To address the power consumption challenges, advanced energy-efficient techniques are imperative. These techniques include the use of advanced antenna technologies, dynamic frequency and power management, and low-power transceivers. For instance, the deployment of intelligent energy harvesting methods can significantly reduce the energy consumption of 6G networks, which are anticipated to support the next generation of XR applications Furthermore, the use of edge computing to offload high-performance computing tasks from the device to the network can reduce both the energy consumption of mobile devices and the end-to-end latency.

The architecture of XR systems also plays a crucial role in managing power consumption. By distributing spatial mapping and rendering processes to edge servers, the energy consumption of XR devices can be reduced by threefold to sevenfold, depending on the level of offloading. This approach enables the design of lightweight, eyeglass-style XR devices with extended battery life.

Moreover, the integration of simultaneous wireless information and power transfer at millimeter-wave (mmWave) and Terahertz (THz) bands holds potential for addressing power consumption issues. Such technologies can provide both communication and power transfer capabilities, thereby reducing the need for large batteries and minimizing device weight.

A distributed system targeted for extended reality (XR) applications comprises various constituent elements, each playing a crucial role in ensuring seamless operation and immersive experiences. These elements can be categorized into local components (e.g., user equipment, companion devices, controllers) and remote components (e.g., edge and cloud infrastructure).

Local Components of an XR system may include: a User Equipment (UE), a companion device, and/or a controller. A User Equipment (UE) may be, or may include, a Head-Mounted Display (HMD), XR Glasses, Smartphones/Tablets, and/or Peripheral Devices. A Head-Mounted Display (HMD) may be, or may include, a wearable device providing the user with an immersive XR experience by displaying 3D visuals and tracking head movements. XR Glasses may be, or may include, lightweight and stylish glasses designed to replace bulky HMDs, relying heavily on computation offloading to remote servers for processing. Smartphones/Tablets may serve as companion devices, providing additional computational power or acting as controllers for XR applications. Peripheral Devices may be, or may include, controllers, sensors, and tracking devices that enhance user interaction and experience within the XR environment.

Companion Device may be, or may include, a tethered companion device and/or wearable devices. Tethered Companion Device may be, or may include, a smartphone or tablet, this device provides additional computational resources and connectivity support for the primary XR device. Wearable devices may be, or may include, smartwatches and other wearables that provide input data and enhance user interaction.

A Controller may be, or may include, a one or more local controllers. Local controllers may manage the local XR devices, handling tasks such as user input processing, device synchronization, and initial data processing before offloading to remote servers.

Remote Components of an XR system may include edge infrastructure, cloud infrastructure, and/or network components. Edge Infrastructure may be, or may include, edge servers and/or an edge cloud. Edge servers may be located close to the user to reduce latency and provide real-time processing capabilities for XR applications. They handle tasks such as XR rendering, object tracking, and sensor data processing. The edge cloud may be, or may include, a network of edge servers providing distributed computing resources to support XR applications, ensuring load balancing and efficient resource utilization.

The Cloud Infrastructure may be, or may include, cloud servers and/or a spatial-computing server. The cloud servers may provide extensive computational power and storage capabilities, handling more complex and resource-intensive tasks such as spatial mapping, large-scale data processing, and long-term data storage. The spatial-computing server may collect and processes data from multiple sources to create spatial maps, assisting in localization and providing updated spatial data to users.

Network Components of an XR system may be, or may include, 5G/6G Networks and/or Mobile Edge Compute (MEC). The 5G/6G Networks may provide the necessary bandwidth, low latency, and high reliability required for XR applications. They facilitate seamless communication between local and remote components, ensuring a smooth and immersive user experience. The Mobile Edge Compute (MEC) may be, or may include, part of the 5G network architecture, MEC sites are deployed to provide localized processing power, reducing latency and improving the responsiveness of XR applications.

In some aspects, an XR system may involve a Unified Execution Environment that acts as an operating system, providing fundamental functionalities and services on top of distributed and heterogeneous network, compute, and storage assets. It simplifies the development and deployment of distributed XR applications by offering capabilities such as compute service access, dynamic network adaptation, and user/data mobility support. Additionally or alternatively, the XR system may involve Service Orchestration including Orchestrated AR Services and/or Edge-based Service Orchestration. Orchestrated AR Services involves the computation offloading of GPU-intensive tasks to edge servers, reducing end-user device energy consumption and increasing accuracy by utilizing larger machine learning models with minimal latency. Edge-based Service Orchestration may optimize the trade-off between energy consumption and computational efficiency, ensuring efficient resource utilization and improved user experience.

By leveraging these constituent elements, a distributed system for XR applications can provide high-quality, immersive experiences while maintaining efficiency and scalability.

Architectural possibilities for distributed extended reality (XR) systems encompass several configurations, each with unique characteristics and benefits. These architectures leverage various combinations of local and remote computational resources to deliver immersive XR experiences efficiently.

In a Client-Server Architecture, XR devices (clients) connect to powerful remote servers for processing and rendering tasks. The XR device captures user inputs and environmental data, which are then transmitted to the server. The server processes the data, performs rendering, and sends back the resultant XR content to the client for display. This architecture reduces the computational load on the XR device, enabling the use of lightweight XR devices. However, it necessitates high-bandwidth, low-latency network connections to ensure real-time performance and may raise privacy and security concerns due to data transmission.

An Edge Computing Architecture involves edge servers located closer to the user handling significant portions of the processing tasks. The XR device offloads computationally intensive tasks to the edge servers, thereby reducing latency compared to cloud-only solutions. This architecture comprises XR devices, edge servers, and cloud servers, with the latter handling non-time-critical tasks and providing additional computational resources. The primary advantage is the lower latency, which improves user experience. However, this approach requires the deployment of edge infrastructure and complex coordination between edge and cloud servers.

A Split Rendering Architecture represents another architectural possibility. In this configuration, the rendering workload is divided between the XR device and remote servers. Basic rendering tasks are performed on the XR device, while more complex tasks are offloaded to remote servers. This architecture balances the computational load between the XR device and remote servers, enhancing performance and reducing latency. Efficient synchronization between local and remote rendering tasks is crucial for seamless operation, and network reliability is a key consideration.

A Multi-Access Edge Computing (MEC) Architecture utilizes MEC to bring cloud computing capabilities to the edge of the network. XR devices offload processing tasks to MEC servers located at the network edge, significantly reducing latency by processing data closer to the user. This architecture includes XR devices, MEC servers, and central cloud servers, with the latter offering additional computational resources and handling non-time-critical tasks. The MEC architecture enhances scalability and flexibility of XR applications but requires extensive deployment of MEC infrastructure and complex coordination between MEC and central cloud servers.

A Hybrid Cloud-Edge Architecture combines cloud and edge computing to optimize performance and resource utilization. XR devices offload tasks to both edge servers and cloud servers based on task requirements and network conditions. This architecture maximizes the benefits of both cloud and edge computing, providing a balanced approach to handling computationally intensive XR tasks. It addresses the limitations of relying solely on either cloud or edge resources, offering a flexible and scalable solution for XR applications.

The typical structure and functions of a Head-Mounted Display (HMD) as an extended reality (XR) distributed system element can be elucidated by examining its core components and connectivity features. An HMD is a wearable device designed to position a display in front of one or both of the user's eyes, streaming data, images, and other information directly into the user's field of vision. The display can vary between being transparent, as in augmented reality (AR) devices that superimpose digital information onto real-world objects, and non-transparent, as in virtual reality (VR) devices that present purely virtual environments without visibility of the real world.

The primary components of an HMD encompass optical systems, tracking sensors, cameras, and XR-related processing units. The optical systems include the display and lenses, which are essential for rendering the visual content that the user interacts with. Tracking sensors, such as gyroscopes, accelerometers, and magnetometers, monitor the user's head movements and orientation, enabling real-time adjustments to the visual content to maintain an immersive experience. Cameras are integrated to capture the surrounding environment, which is particularly crucial for AR applications where digital information is overlaid onto real-life objects.

XR-related processing units within an HMD typically consist of Graphics Processing Units (GPUs), Central Processing Units (CPUs), and Application-Specific Integrated Circuits (ASICs) dedicated to media encoding and decoding. These processing units handle the computationally intensive operations required for rendering high-quality graphics and performing spatial computations. Spatial computation functionalities include simultaneous localization and mapping (SLAM), object detection, and object tracking, which are vital for understanding and interacting with the local environment.

Connectivity features of an HMD play a pivotal role in its operation within a distributed XR system. Modern HMDs often incorporate wireless connectivity options, such as Wi-Fi and 5G, to facilitate communication with remote servers and other devices. The inclusion of a 5G modem, for instance, enables high-speed, low-latency data transmission, which is essential for real-time XR applications. This connectivity allows the HMD to offload computationally intensive tasks to remote servers, thereby enhancing performance and reducing the device's complexity. Offloading tasks such as SLAM involves transmitting compressed sensor data, including video and lidar, to a remote server that processes the data and sends back the necessary information to the HMD. This process allows for more powerful processing capabilities, extended battery life, and reduced heat generation within the HMD.

In a distributed XR system, the HMD's role extends to facilitating shared immersive multi-user experiences. By offloading SLAM and other spatial computation tasks to a remote server, the system can create and share maps of the environment among multiple users. This capability enables efficient positioning of HMDs entering previously mapped environments and allows for object persistence across different user sessions. The uplink bitrate for transmitting sensor data depends on the resolution and level of compression, necessitating high-bandwidth connectivity to ensure smooth operation.

The typical structure and functions of a companion device as an extended reality (XR) distributed system element can be characterized by its role in augmenting the computational capabilities and connectivity of XR head-mounted displays (HMDs) or AR glasses. A companion device, often a smartphone or a similar portable computing device, is tethered to the XR device to offload and manage the intensive processing tasks that the XR device may not be able to handle independently due to its limited form factor and power constraints.

The companion device comprises several key components, including a central processing unit (CPU), a graphics processing unit (GPU), memory storage, and communication interfaces. The CPU and GPU are pivotal in executing computationally demanding tasks such as rendering high-quality graphics, performing simultaneous localization and mapping (SLAM), and processing sensor data from the XR device. These units ensure that the XR experience remains immersive and interactive by handling complex calculations and rendering operations that would otherwise overwhelm the XR device's internal processors.

Memory storage within the companion device is utilized for storing large datasets, including 3D models, textures, and precomputed data necessary for the XR applications. This storage capability allows the XR system to access and manipulate extensive data sets in real-time, which is crucial for maintaining the fidelity and responsiveness of the XR experience. The communication interfaces, which typically include wireless technologies such as Wi-Fi and Bluetooth, facilitate seamless data transfer between the companion device and the XR device. These interfaces ensure low-latency communication, which is essential for synchronizing the visual and sensory feedback with the user's movements and interactions.

In addition to these core components, the companion device may also incorporate specialized sensors, such as cameras and inertial measurement units (IMUs), to enhance the tracking and environmental awareness of the XR system. These sensors work in tandem with those on the XR device to provide a more comprehensive understanding of the user's surroundings, enabling more accurate and responsive interactions within the XR environment.

The functions of the companion device in an XR distributed system extend beyond mere computational support. It serves as a bridge between the XR device and external networks, including cloud and edge computing resources. By leveraging high-speed wireless connectivity, the companion device can offload certain processing tasks to remote servers, thereby reducing the computational burden on both the XR device and the companion device itself. This offloading mechanism is especially beneficial for tasks that require substantial computational power or large-scale data processing, such as advanced SLAM algorithms or real-time collaborative XR experiences.

Furthermore, the companion device plays a critical role in managing power consumption and thermal performance within the XR system. By distributing the processing load and offloading intensive tasks, the companion device helps to extend the battery life of the XR device and prevent overheating, which is crucial for maintaining user comfort and safety during extended XR sessions.

The typical structure and functions of a controller as an extended reality (XR) distributed system element can be elucidated by examining its integral components and the roles it performs within the XR ecosystem. A controller in the context of XR systems is a device that facilitates user interaction with virtual or augmented environments, providing input through various means such as buttons, joysticks, touchpads, and motion sensing capabilities.

The structural composition of an XR controller includes several key elements: an ergonomic housing, input mechanisms, sensors, communication modules, and power sources. The ergonomic housing is designed to fit comfortably in the user's hand, allowing for prolonged use without causing discomfort. This housing encases the input mechanisms, which typically consist of buttons, triggers, joysticks, and touch-sensitive surfaces. These input mechanisms enable the user to interact with the virtual environment by providing commands and controls that are translated into corresponding actions within the XR application.

Sensors embedded within the controller play a crucial role in capturing the user's motions and translating them into digital inputs. These sensors may include accelerometers, gyroscopes, and magnetometers, which collectively enable the controller to detect orientation, tilt, and movement. Advanced XR controllers may also incorporate optical sensors or cameras to enhance motion tracking accuracy. The data collected by these sensors is processed to determine the spatial position and orientation of the controller, allowing for precise interaction within the XR environment.

Communication modules within the controller are responsible for transmitting input data to the XR system. These modules typically utilize wireless communication protocols such as Bluetooth or proprietary RF technologies to ensure low-latency and reliable data transfer. The communication modules ensure that the input data from the controller is seamlessly integrated into the XR system, providing real-time feedback and interaction capabilities.

Power sources for XR controllers are generally comprised of rechargeable batteries, which provide the necessary energy to operate the device. The power management system within the controller ensures efficient usage of battery power, extending the operational duration between charges. Some controllers may also feature haptic feedback mechanisms, which provide tactile sensations to the user, enhancing the immersive experience by simulating physical interactions within the virtual environment.

The functions of an XR controller extend beyond mere input collection. It serves as a critical interface between the user and the XR system, enabling intuitive and natural interactions. The controller interprets user inputs and translates them into commands that the XR application can execute. This functionality allows users to navigate virtual spaces, manipulate virtual objects, and interact with digital elements in a manner that feels responsive and engaging.

Furthermore, the controller's motion tracking capabilities enable it to act as a pointer or tool within the XR environment. By accurately capturing the user's hand movements, the controller allows for precise selection, manipulation, and control of virtual objects. This capability is particularly important in applications that require fine motor skills, such as virtual design, gaming, and simulation training.

The typical structure and functions of an edge device as an extended reality (XR) distributed system element can be comprehensively described by examining its core components and operational roles within the XR ecosystem. An edge device in the context of XR systems serves as a pivotal intermediary that bridges the computational gap between the XR client devices (such as head-mounted displays) and the cloud or central servers, thereby enhancing the performance, efficiency, and user experience of XR applications.

The structural composition of an edge device includes several essential components: a high-performance central processing unit (CPU), a graphics processing unit (GPU), memory storage, network interfaces, and power management systems. The CPU and GPU within the edge device are tasked with executing computationally intensive tasks such as rendering high-fidelity graphics, processing sensor data, and performing simultaneous localization and mapping (SLAM). These units are capable of handling large-scale computations that are offloaded from the XR client devices, thereby alleviating the processing burden on the client devices and enabling them to maintain a smaller form factor and longer battery life.

Memory storage within the edge device is utilized for storing extensive datasets, including 3D models, textures, and spatial maps. This storage capability allows the edge device to quickly access and manipulate data required for XR applications, ensuring real-time processing and responsiveness. Network interfaces, which typically include high-speed wireless and wired communication technologies, facilitate the seamless transfer of data between the edge device, XR client devices, and cloud servers. These interfaces ensure low-latency communication, which is critical for synchronizing the visual and sensory feedback with the user's interactions in the XR environment.

The power management system within the edge device is designed to optimize energy consumption while maintaining high computational performance. By efficiently managing power usage, the edge device can support prolonged operational periods and reduce the overall energy footprint of the XR system. Additionally, the edge device may incorporate specialized components such as field-programmable gate arrays (FPGAs) or application-specific integrated circuits (ASICs) to further enhance computational efficiency and performance for specific XR tasks.

The functions of an edge device in an XR distributed system extend beyond mere computational support. It serves as a critical node for offloading and processing data-intensive tasks that the XR client devices cannot handle independently. This offloading mechanism enables more powerful and complex XR experiences by leveraging the edge device's superior computational capabilities. For instance, tasks such as high-resolution rendering, advanced SLAM algorithms, and complex object recognition can be performed on the edge device, thereby freeing up resources on the XR client devices and enhancing their performance.

Moreover, the edge device plays a crucial role in managing and distributing computational workloads across the XR system. By orchestrating the distribution of tasks between the client devices, the edge device, and the cloud, it ensures optimal utilization of available resources and maintains a balance between performance and energy efficiency. This orchestration is particularly important for maintaining low latency and high-quality user experiences in XR applications, where real-time processing and responsiveness are paramount.

In addition to computational offloading, the edge device also facilitates the aggregation and synchronization of data from multiple XR client devices. This capability is essential for collaborative XR experiences, where multiple users interact within the same virtual or augmented environment. The edge device ensures that data from different client devices is accurately synchronized and integrated, providing a coherent and seamless experience for all users involved.

The technical challenges associated with the optical and display elements of a head-mounted display (HMD) for extended reality (XR) use cases can be elucidated by examining the intricacies of their design, functionality, and integration within the XR ecosystem. The primary optical and display components of an HMD include the display panels, optical lenses, and various sensors, each presenting unique challenges that must be addressed to achieve optimal performance and user experience.

One significant challenge pertains to the design and implementation of the display panels, which render high-resolution images directly in front of the user's eyes. These panels must provide a wide field of view (FoV) while maintaining high pixel density to ensure a clear and immersive visual experience. Achieving this balance is complicated by the need to minimize the size and weight of the HMD to enhance comfort and usability. High-resolution displays with a wide FoV often require advanced manufacturing techniques and materials, increasing production complexity and cost. Additionally, the display panels must have high refresh rates to prevent motion sickness and visual fatigue, necessitating the use of fast-switching display technologies such as OLED or microLED.

The optical lenses in an HMD present another set of challenges. These lenses focus and direct the light from the display panels into the user's eyes, creating a coherent and immersive visual experience. The lenses must correct for various optical aberrations, such as chromatic aberration, distortion, and field curvature, which can degrade image quality and cause visual discomfort. Designing lenses that provide a wide FoV while correcting for these aberrations requires sophisticated optical engineering and often involves trade-offs between lens complexity, weight, and cost. Furthermore, the lenses must be adjustable to accommodate users with different interpupillary distances (IPD) and visual prescriptions, adding another layer of complexity to the design.

Another critical challenge is the integration of tracking sensors within the HMD. These sensors, which may include accelerometers, gyroscopes, magnetometers, and cameras, are essential for tracking the user's head movements and ensuring that the virtual environment responds accurately and in real-time. The placement and calibration of these sensors must be precise to avoid tracking errors and latency, which can disrupt the immersive experience and cause motion sickness. Additionally, the sensors must operate efficiently to minimize power consumption and extend the battery life of the HMD.

The see-through capability of augmented reality (AR) HMDs introduces additional challenges. AR HMDs require transparent or semi-transparent displays that can overlay digital information onto the real-world view without obstructing the user's vision. This capability can be achieved using optical see-through or video see-through technologies, each with its own set of challenges. Optical see-through HMDs must ensure that the projected images are bright and clear enough to be visible in various lighting conditions while maintaining transparency for a natural view of the surroundings. This often requires the use of advanced optical combiners and coatings, which can be difficult to manufacture and integrate. Video see-through HMDs, on the other hand, must capture and display real-time video of the surroundings with minimal latency and high fidelity, which demands high-performance cameras and image processing capabilities.

Power consumption and heat management are also significant challenges in the design of HMDs. High-resolution displays, advanced optical systems, and numerous sensors all contribute to the power demands of the device. Efficient power management is crucial to ensure that the HMD can operate for extended periods without frequent recharging. Additionally, the heat generated by the electronic components must be effectively dissipated to prevent discomfort and potential damage to the device. This requires innovative thermal management solutions that can maintain a balance between performance and comfort.

The optics and display technologies being considered for a head-mounted display (HMD) in extended reality (XR) use cases encompass a variety of advanced methodologies and components aimed at enhancing visual performance, user comfort, and overall immersive experience. One prominent technology under consideration is the use of waveguides. Waveguides are optical components that guide light from the display source to the user's eyes, enabling the creation of high-quality images while maintaining a lightweight and compact form factor. This technology leverages principles of total internal reflection to transmit light through thin, flat substrates, which can be integrated seamlessly into the HMD's optical system.

Waveguides offer several advantages for XR applications, including the capability to produce wide field-of-view (FoV) displays while minimizing the bulk and weight of the device. This is achieved by embedding diffraction gratings or holographic elements within the waveguide material, which can manipulate and direct light precisely to the user's eyes. Such configurations allow for the efficient delivery of bright, high-contrast images even in varying ambient light conditions, which is crucial for both augmented reality (AR) and virtual reality (VR) applications.

Another technology being explored is the use of freeform optics. Freeform optics involve the design of lenses and mirrors with non-traditional, non-spherical shapes that can correct for optical aberrations more effectively than conventional optics. These components can be tailored to the specific requirements of XR HMDs, providing improved image clarity and reduced distortion across the entire FoV. The integration of freeform optics into HMDs enables the creation of more compact and ergonomically designed devices without compromising optical performance.

Additionally, holographic optical elements (HOEs) are being investigated for their potential to enhance XR display systems. HOEs can be used to create complex optical functions such as beam shaping, splitting, and combining within a thin and lightweight format. These elements can be fabricated using advanced photolithography techniques, allowing for precise control over their optical properties. By incorporating HOEs into the optical path of an HMD, manufacturers can achieve high-resolution, wide-FoV displays that are also lightweight and comfortable for extended use.

The development of retinal projection displays represents another innovative approach in XR optics. Retinal projection technology involves projecting images directly onto the retina using low-power laser beams. This method can produce high-resolution images with a wide FoV while ensuring minimal eye strain and fatigue. Retinal projection displays can also accommodate users with varying visual prescriptions without the need for additional corrective lenses, thereby enhancing accessibility and user experience.

In terms of display technologies, organic light-emitting diode (OLED) and micro-light-emitting diode (microLED) displays are being considered for their superior performance characteristics. OLED displays offer high contrast ratios, fast response times, and wide color gamuts, making them well-suited for immersive XR applications. MicroLED displays, on the other hand, provide even higher brightness levels and energy efficiency, along with the potential for greater pixel densities. These attributes enable microLED displays to deliver exceptionally sharp and vibrant images, which are essential for creating realistic and engaging virtual environments.

The integration of these advanced optics and display technologies into HMDs for XR use cases necessitates meticulous engineering and design efforts. The goal is to achieve a harmonious balance between visual performance, device ergonomics, and user comfort. By leveraging waveguides, freeform optics, holographic optical elements, retinal projection displays, and cutting-edge display panels such as OLED and microLED, XR HMDs can provide immersive and high-quality visual experiences that meet the demanding requirements of both AR and VR applications.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs) (which may also be referred to as a head-mounted devices), XR glasses (e.g., AR glasses, MR glasses, etc.) (also referred to as smart or network-connected glasses), among others. In some cases, XR glasses are an example of an HMD. In some cases, an XR system can track parts of the user (e.g., a hand and/or fingertips of a user) to allow the user to interact with items of virtual content.

XR systems can include virtual reality (VR) systems facilitating interactions with VR environments, augmented reality (AR) systems facilitating interactions with AR environments, mixed reality (MR) systems facilitating interactions with MR environments, and/or other XR systems.

For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In some cases, an XR system can match the relative pose and movement of objects, devices, and/or points in the physical world. For example, an XR system can use tracking information to calculate the relative pose of devices, objects, and/or points of the real-world environment in order to match the relative position and movement of the devices, objects, and/or points of the real-world environment. In some examples, the XR system can use the pose and movement of one or more devices, objects, and/or points of the real-world environment to render content relative to the real-world environment in a convincing manner. The relative pose information can be used to match virtual content with the user's perceived motion and the spatio-temporal state of the devices, objects, and/or points of the real-world environment. Matching virtual content to devices, objects, and points of the real-world environment may be referred to as “anchoring.” For example, a virtual object may be anchored to a device, object, or point of the real-world environment. In some cases, an XR system can track parts of the user (e.g., a hand and/or fingertips of a user) to allow the user to interact with items of virtual content.

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

A virtual representation of a user may be used to represent the user in a virtual environment. A virtual representation of a user is also referred to herein as an avatar. An avatar representing a user may mimic an appearance, movement, mannerisms, and/or other features of the user. In some examples, the user may desire that the avatar representing the person in the virtual environment appear as a digital twin of the user. In any virtual environment, it is important for an XR system to efficiently generate high-quality avatars (e.g., realistically representing the appearance, movement, etc. of the person) in a low-latency manner. It can also be important for the XR system to render audio in an effective manner to enhance the XR experience.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

As mentioned above, XR systems may track a pose (e.g., orientation and position) of a display of the XR system. Tracking the pose of the display may allow the XR system to display virtual content relative to the real world (e.g., to anchor virtual content to points in the real world). For example, tracking the pose of the display may allow the XR system to display virtual content within a field of view of a user such that as the user moves and/or reorients the display, the virtual content remains in the same position in the user's field of view of the real world.

In some cases, a display of an XR system (e.g., a head-mounted display (HMD), AR glasses, etc.) may include one or more inertial measurement units (IMUs) and may use measurements from the IMUs (e.g., IMU data) to track a pose of the display. For example, the XR system may assume an initial position of the display and track a position and/or orientation of the display based on acceleration measured by the IMUs. IMUs may include accelerometers, magnetometers, and/or gyroscopes (also referred to as gyroscopic sensors).

Additionally or alternatively, some XR systems may use a computational-geometry technique (e.g., a visual-odometry technique, a visual simultaneous localization and mapping (VSLAM), which may also be referred to as simultaneous localization and mapping (SLAM)) or other image-based techniques to track a pose of a display of such XR systems. In VSLAM, a device can capture images of an environment and keep track of the device's pose within the environment based on tracking where objects in the environment appear in the images, for example, as the device moves and/or reorients relative to the objects.

Degrees of freedom (DoF) refer to the number of basic ways a rigid object can move in three-dimensional (3D) space. In the context of systems that track movement through an environment, such as XR systems, degrees of freedom can refer to which of six degrees of freedom the system is capable of tracking. For example, 3DoF systems generally track the three rotational DoF - pitch, yaw, and roll. A 3DoF headset, for instance, can track the user of the headset turning their head left or right, tilting their head up or down, and/or tilting their head to the left or right. In some aspects, a 3DoF system may use IMU data from an IMU to track an orientation of a display.

6DoF systems can track the three rotational DoF as well as three translational DoF. For example, a 6DoF headset can track the user moving forward, backward, laterally, and/or vertically in addition to tracking the three rotational DoF. In some aspects, a 6DoF system may use image data from a camera (according to a computational-geometry technique) to determine a pose (e.g., orientation and position) of a display.

In the present disclosure, the term “pose” may refer to a position and orientation. Poses may be determined according to six degrees of freedom including three translational degrees of freedom (e.g., x, y, and z dimensions) and three rotational degrees of freedom (e.g., roll, pitch, and yaw). In the present disclosure, the term “orientation” may refer to orientation, for example, according to three rotational degrees of freedom (e.g., roll, pitch, and yaw).

Short range wireless communication enables wireless communication over relatively short distances (e.g., within thirty meters). For example, Radio Frequency Identification (RFID) systems can be used to perform short range wireless communication based on the wireless transfer of data between a reader (e.g., RFID reader device) and a tag or transponder (e.g., RFID tag). RFID systems can be used for identification, tracking, data storage, etc. For example, RFID systems can be used to identify and/or track various items, such as consumer products.

An RFID tag may be attached to an item to be tracked and may include data storage and an antenna. The data storage stores information corresponding to the associated item, such as a product name, a serial number, product information, a manufacturer, etc. The antenna enables the RFID tag to be read by an RFID reader, which transmits an interrogating signal to one or more RFID tags within communication range. RFID tags can be passive, active, or semi-active. Passive RFID tags utilize the interrogating signal from an RFID reader to power a transmission by or from the RFID tag. Active and semi-active RFID tags can include a power source or battery, which can be used to power a transmission by or from the RFID tag.

Radio Frequency Identification (RFID) systems can be used for short range wireless communication between a reader device (e.g., RFID reader) and one or more tags or transponders (e.g., RFID tags). An RFID reader may also be referred to as an “RFID interrogator” and/or an “energizer.” RFID systems can be used to identify and/or track various items that are associated with one or more RFID tags (e.g., various items to which one or more RFID tags are attached). RFID systems can read and/or write information to and/or from (respectively) RFID tags, based on respective wireless communications between an RFID reader and the RFID tags.

For example, an RFID reader (e.g., energizer) can be used to interrogate one or more RFID tags to obtain information of the nearby items that are within communication range of the RFID reader and the interrogation signal. The RFID reader (e.g., energizer) can transmit a radio frequency (RF) signal to perform the energizing and interrogating of the RFID tags. An RFID tag that receives the interrogating RF wave can respond by transmitting another RF wave. An RFID tag may generate the responsive RF wave originally (e.g., in examples where the RFID tag is an active or semi-active tag). An RFID tag may generate the responsive RF wave passively, for instance by reflecting back a portion of the interrogating RFID wave using a backscatter process (e.g., in examples where the RFID tag is a passive tag).

In some examples (e.g., such as in product-related and/or service-related industries, etc.), RFID systems can be used to track objects that are being processed, inventoried, shipped, handled, etc. For example, an RFID tag can be attached to an individual item (e.g., to the packaging of an individual item, etc.) to provide tracking and identification of the individual item. In some examples, an RFID tag can be attached to a collection or group of individual items (e.g., to a pallet of same or similar items being shipped to a store or distribution center, etc.).

An RFID tag attached to a respective item, or attached to a group of items, may store corresponding information thereof. For example, an RFID tag can include a data storage element that stores information corresponding to the item(s) to which the RFID is attached and associated. For instance, RFID tag information can include one or more of a product name, a serial number, product information, a manufacturer, etc. In some examples, the RFID tag can store identification information that is directly indicative of a tagged item, product, object, etc. For instance, an RFID tag can store identification information such as a unique product serial number, etc. In some examples, the RFID tag does not store product or item identification information directly, and stores a unique RFID tag serial number or identification number which may be externally mapped to various item identification information such as product serial numbers, product names, product SKUs, etc.

An RFID reader (e.g., energizer) can transmit an RF signal configured to cause the RFID tags to transmit at least a portion of their respective identification information. The RFID reader can receive (e.g., scan) the identification information transmitted by the one or more RFID tags energized by the RFID reader and can use the identification information to determine the tagged items or products that are nearby to the RFID reader.

In some examples, RFID tags can store item identification information that utilizes various granularity levels for tracking and management of the RFID tagged items. For example, RFID tags can be used to track item types or models by using different RFID tags (e.g., unique identifiers) per item type or item model, with RFID identifier reuse across individual tagged items that are of the same type or model. For instance, the RFID tags used for each item of a particular type may store the same product identifier, and can be used to decrement an inventory count for the particular item whenever a tag is scanned and removed from the shelf, from the store, etc.

In another example, RFID tags can be used to track and identify individual items, based on using a corresponding RFID tag and unique identifier for each individual item of a plurality of RFID-tagged items that are registered with the RFID system. In some examples, individual and unique item identifiers can be implemented based on using individual and unique RFID tag serial numbers or identifiers, which may be mapped separately to a corresponding individual item. In some examples, individual and unique item identifiers can be implemented based on using a product type identifier combined with a unique identifier within that product type. For instance, items can be tagged with their corresponding product SKU and a unique identifier of each item within the corresponding product SKU. In some cases, the unique RFID tag identifiers can be mapped in one or more databases to additional information associated with an item, such as manufacturing data, batch number, specific store location, etc.

RFID systems can be used in a retail environment for purposes such as inventory tracking (e.g., determining when items are removed from shelves, which particular items are removed from shelves and the quantity thereof, etc.). RFID systems can also be used in a retail environment for determining the contents of a shopper's basket, for instance based on reading the RFID tags of items as they are placed in the shopper's basket, reading the RFID tags of the items once they are within the shopper's basket, reading the RFID tags of the items during the checkout process or as the final collection of items is removed from the shopper's basket, etc. As used herein, a shopper's “basket” can refer to any receptacle or volume within which items are placed for temporary storage and/or transport prior to purchase. For example, a shopper's “basket” can include various implementations, such as a handheld-basket, a cart or trolley, a bag or satchel, etc. A shopper's “basket” or “basket contents” may also refer to the hand carry of one or more items by a shopper.

RFID readers can be configured to read hundreds of RFID tags per second, based on the respective RFID tags responding to an interrogation signal from the RFID reader using a corresponding time slot determined for the respective RFID tag. The time slot used by an RFID tag may be assigned by the RFID reader or may be determined by the RFID tags. For example, RFID tags can respond to an interrogation signal based on randomly choosing a time slot within a configured time window for response. In some cases, an anti-collision algorithm can be used to divide a time window into a plurality of discrete time slots for RFID tags responses, within which each RFID tag may randomly choose or be assigned a particular time slot. Each RFID tag transmits its identification information back to the reader in the corresponding or allocated time slot for the RFID tag. Restricting each RFID tag to a particular time slot reduces the chances of a collision occurring when two or more RFID tags attempt to transmit during the same time slot. If a collision occurs, the multiple RFID tags attempting to transmit during the same time slot are not successfully read by the RFID reader and may be configured to select new time slots and retransmit.

RFID systems may commonly be implemented without the capability to perform selective reporting. Selective reporting can be associated with an RFID reader that reports only information associated with RFID tags of interest, where the RFID tags of interest are a subset within a larger plurality of RFID tag reflections that are read by the RFID reader. For instance, anon-selective RFID reader will report the reflected information read for any RFID tag that is within range to respond to the interrogation signal(s) from the reader. A selective RFID reader can perform selective reporting to filter the reflected information received from a plurality of RFID tags and report only the corresponding information associated with a subset of interest. However, the selective reporting of RFID tag identification information does not suppress RFID tags that are not of interest (e.g., not included in the subset of interest) from responding to the interrogation signal (e.g., the RFID tags not of interest will still respond and consume a time slot). Additionally, in some examples it can be difficult or impossible to determine in advance which RFID tags belong to the subset of interest and which RFID tags do not belong to the subset of interest. For instance, in use cases such as shopper basket contents determination (e.g., identifying the products placed into a shopper's basket in a store), the primary task for which the RFID system is utilized may be to determine the subset of interest comprising RFID tags of items selected for purchase by the shopper and placed into the basket.

In some cases, an RFID system can utilize one or more RFID readers (e.g., energizers) with antenna configurations that are adjusted to limit the reading range and/or reading zone. For example, an RFID reader can be configured with a reading zone that corresponds to an angular section of an omnidirectional or 660° reading zone. The selective reading of RFID tags based on antenna configurations of an RFID reader can be challenging when the spatial relationship between the RFID reader(s) and the RFID tag(s) is unknown and/or changing. For instance, in a basket content determination example, the relative spatial positions of the RFID reader and the RFID tags in the shopper's basket can vary, and/or the relative spatial positions of the RFID reader and the RFID tags of items on the shelves can vary.

In another example, selective RFID tag reading may be based on spatial isolation between the RFID reader and one or more RFID tags. For example, by spatially isolating an RFID reader from RFID tags that are not of interest (e.g., using an attenuation barrier, increasing physical separation distance, etc.), the RFID reader can be used to read RFID tags of interest that are not spatially isolated. An example of selective RFID tag reading based on spatial isolation is the reading of basket contents at a spatially isolated checkout area within a store or other retail environment, where the checkout process is performed away from the products on the shelves. Selective RFID tag reading based on spatial isolation may limit RFID tag reading to only being performed in particular areas (e.g., at the checkout area, but not within the store aisles) and/or at particular times (e.g., at checkout, but not during shopping).

While online solutions exist that can profile users and predict what they may be interested in from past purchases, the current in-store retail shopping experience is very low-tech. Information about what users are currently doing and/or looking at is not utilized.

Additionally, current methods of collaborating with a non-collocated person while searching for an item the non-collocated person may want (e.g., voice/video call, text with photos) are slow and error prone. This may be especially true when searching for an item the searcher may be unfamiliar with (e.g., a “basin” wrench) or when there are many similar items to choose from (e.g., pastas).

Systems, apparatuses, methods (also referred to as processes), and computer-readable media (collectively referred to herein as “systems and techniques”) are described herein for assisted searching in a physical environment. For example, the systems and techniques described herein may assist a person in searching for and/or selecting an object in a physical environment. The systems and techniques may leverage data from both internet of things (IOT) devices and extended reality (XR) device to enhance searching for and/or selecting objects (e.g., an in-store shopping experience).

The systems and techniques include an “XR/IOT Shopping System,” for example, a shopping system that integrates XR devices (e.g., head-mounted devices (HMDs)) with various in-store IOT devices. The systems and techniques may capture a person's real-time behavior while they browse, inspect, and select products and improve the shopping experience, making it a more stream-lined for the person and more cost efficient for the shop owner(s).

For example, according to various aspects of the present disclosure, an XR device can detect and/or log what a user is looking at, dwell time (e.g., how long the user is looking at an object), what objects the user picks up, what objects the user does not pick up, what the user does with objects that the user picked up. The systems and techniques may offer suggestions based on these and/or other interactions between the user and various objects. For example, the systems and techniques may suggest different objects based on value (e.g., price), ingredients, coupons, promotions, etc. Additionally or alternatively, the systems and techniques may take user's preferences to provide suggestions (e.g., a gluten allergy) that indicates current product affects user or the user's family members.

For instance, the systems and techniques may opportunistically obtain camera data from an XR device and/or specifically request particular information from the XR device when, or if, the user is looking at particular shelves, products, areas of a store/factory/etc.

Additionally or alternatively, the systems and techniques may gamify XR content of picked-up objects, for example, before the picked-up objects go into a cart of the user. For example, when a user picks up objects virtual content may be anchored to the object to cause the object to glow or change color.

Additionally or alternatively, the systems and techniques may leverage functionalities of an XR device for checkout and/or inventory management. For example, according to an “inside-out approach” an XR device may detect an object and remove from inventory with same accuracy of bar code scan. Additionally or alternatively, the systems and techniques may initiate a transaction based on objects determined to be in the cart of the user by an XR device.

Additionally or alternatively, the systems and techniques may include an “XR Collaboration Module,” for example, a collaboration module that allows a non-collocated remote user to see (e.g., via tablet, phone, XR device, etc.) what a local user (shopper) sees with their XR HMD, allowing the remote user to point, touch, gesture, circle, or speak to indicate an item of interest via “highlighting” it in the shopper's view, which enables the shopper to easily select the correct item.

For example, the systems and techniques may enable and/or enhance interactions between an XR user in a physical environment and a remote user. For example, one or more images (e.g., a video stream) from a camera of an XR user in the physical environment may be shared with the remote user. The remote user can view the one or more images using a remote device. The remote user can select (e.g., circle) an object they want in at least one of the images. The XR device may then anchor virtual content (e.g., a circle, coloring, a glow) to the object in the display of the XR device of the user in physical environment. The XR user in the physical environment can then buy or pick up that object.

Various aspects of the application will be described with respect to the figures below.

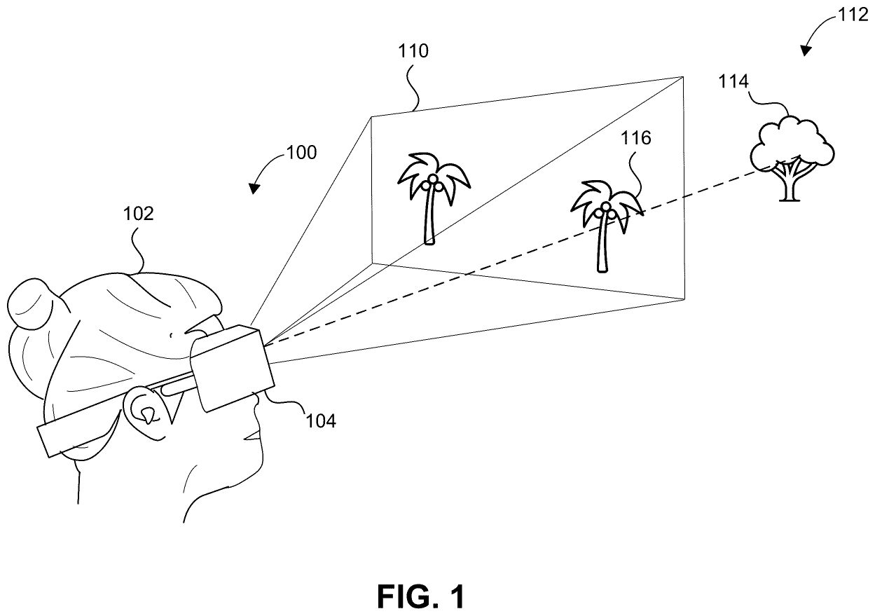

FIG. 1 is a diagram illustrating an example extended-reality (XR) system 100, according to various aspects of the disclosure. As shown, XR system 100 includes an XR device 104. XR device 104 may implement, as examples, image-capture, object-detection, object-tracking, gaze-tracking, view-tracking, localization (e.g., determining a location of XR device 104), pose-tracking (e.g., tracking a pose of XR device 104), content-generation, content-rendering, computational, communicational, and/or display aspects of extended reality, including virtual reality (VR), augmented reality (AR), and/or mixed reality (MR).

For example, XR device 104 may include one or more scene-facing cameras that may capture images of a scene 112 in which a user 102 uses XR device 104. XR device 104 may detect objects (e.g., object 114) in scene 112 based on the images of scene 112. In some aspects, XR device 104 may include one or more user-facing cameras that may capture images of eyes of user 102. XR device 104 may determine a gaze of user 102 based on the images of user 102. In some aspects, XR device 104 may determine an object of interest (e.g., object 114) in scene 112 (e.g., based on the gaze of user 102, based on object recognition, and/or based on a received indication regarding object 114). XR device 104 may obtain and/or render XR content 116 (e.g., text, images, and/or video) for display at XR device 104. XR device 104 may display XR content 116 to user 102 (e.g., within a field of view 110 of user 102). In some aspects, XR content 116 may be based on an object in scene 112. For example, XR content 116 may be an altered version of object 114. As another example, XR content 116 may appear to interact with object 114. For example, object 114 may be a tree and XR content 116 may include a monkey climbing the tree.

In some aspects, XR device 104 may display XR content 116 in relation to the view of user 102 of the object of interest. For example, XR device 104 may overlay XR content 116 onto object 114 in field of view 110. In any case, XR device 104 may overlay XR content 116 (whether related to object 114 or not) onto the view of user 102 of scene 112. XR device 104 may anchor XR content 116 to object 114, for example, such that as user 102 moves their head (e.g., changing field of view 110), XR content 116 remains in the line of sight between the eyes of user 102 and object 114. To do this, XR device 104 may track a pose of XR device 104 (e.g., based on movement data from one or more inertial measurement units (IMUs) of XR device 104.

In a “see-through” configuration, XR device 104 may include a transparent surface (e.g., optical glass) such that XR content 116 may be displayed on (e.g., by being projected onto) the transparent surface to overlay the view of user 102 of scene 112 as viewed through the transparent surface. In a “pass-through” configuration or a “video see-through” (VST) configuration, XR device 104 may include a scene-facing camera that may capture images of scene 112. XR device 104 may display images or video of scene 112, as captured by the scene-facing camera, and XR content 116 overlaid on the images or video of scene 112.

In various examples, XR device 104 may be, or may include, a head-mounted device (HMD), a virtual reality headset, and/or smart glasses. XR device 104 may include one or more cameras, including scene-facing cameras and/or user-facing cameras, a GPU, one or more sensors (e.g., such as one or more inertial measurement units (IMUs), image sensors, and/or microphones), one or more communication units (e.g., wireless communication units), and/or one or more output devices (e.g., such as speakers, headphones, displays, and/or smart glass). In other examples, XR device 104 may include a handheld device with a display, such as a smartphone or tablet.

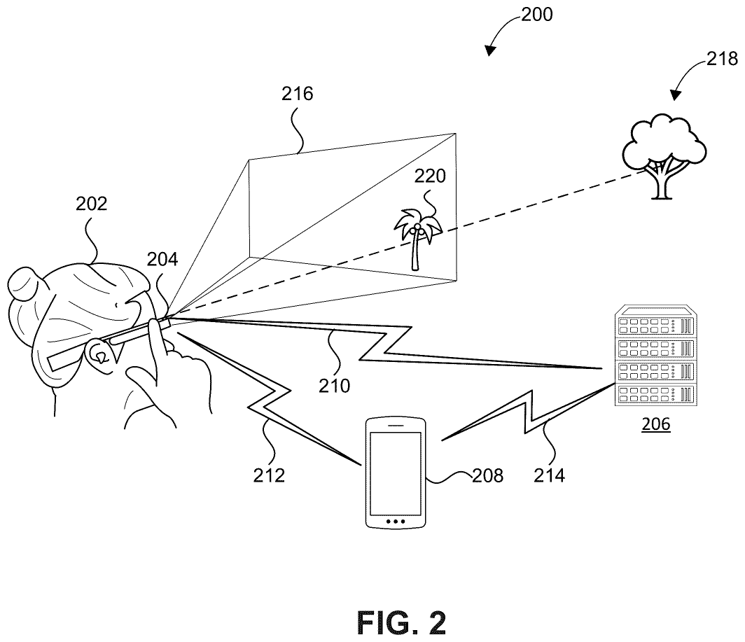

FIG. 2 is a diagram illustrating an example extended reality (XR) system 200, according to aspects of the disclosure. In some aspects, an XR system may be, or may include, two or more devices. The two or more devices of XR system 200 may perform the operations described with regard to XR system 100 of FIG. 1.

For example, XR system 200 includes a display device 204 and a processing device 206. In some aspects, display device 204 and processing device 206 may implement a communication link 210 between display device 204 and processing device 206. Communication link 210 may be a wireless connection according to any suitable wireless protocol, such as, a broadband-cellular-network protocol, for example, a fifth generation (5G) wireless cellular protocol.

In some aspects, XR system 200 may include a companion device 208. Display device 204 and companion device 208 and may implement a communication link 212 between display device 204 and companion device 208 and companion device 208 and processing device 206 may implement a communication link 214 between companion device 208 and processing device 206. Communication link 212 may be a wireless connection according to any suitable wireless protocol, such as, for example, Institute of Electrical and Electronics Engineers (IEEE) 802.11 (Wi-Fi), IEEE 802.15, or Bluetooth®. Communication link 214 may be a wireless connection according to any suitable wireless protocol, such as, a broadband-cellular-network protocol, for example, a fifth generation (5G) wireless cellular protocol.

Display device 204, processing device 206, and/or companion device 208 may collectively implement as examples, image-capture, object-detection, object-tracking, gaze-tracking, view-tracking, localization, pose-tracking, content-generation, content-rendering, computational, communicational, and/or display aspects of XR. For example, display device 204 may implement image-capture, gaze-tracking, view-tracking, localization, pose-tracking, communicational, and/or display aspects of XR. Processing device 206 may implement object-detection, object-tracking, localization, content-generation, content-rendering, computational, and/or communicational, aspects of XR. Additionally or alternatively, companion device 208 may implement at least a portion of one or more of localization, pose-tracking, communicational, object-detection, object-tracking, localization, content-generation, content-rendering, and/or computational aspects of XR.

For example, display device 204 may capture and/or generate data, such as image data (e.g., from user-facing cameras and/or scene-facing cameras) and/or motion data (from an inertial measurement unit (IMU)). Display device 204 may provide the data to processing device 206, for example, through communication link 210 or through communication link 212, companion device 208, and communication link 214.

Processing device 206 may process the data and/or other data (e.g., data received from another source or data stored at processing device 206). For example, processing device 206 may detect, recognize, and/or track objects in scene 218 based on the images of scene 218. Further, processing device 206 may generate (or obtain) XR content 220 to be rendered for display at display device 204. Processing device 206 may render XR content 220 to be appropriate for display at display device 204 (e.g., based on a pose of display device 204). Processing device 206 may provide rendered XR content 220 to display device 204 through communication link 210 (or communication link 214, companion device 208, and communication link 212) and display device 204 may display XR content 220 in field of view 216 of user 202.

In various examples, display device 204 may be, or may include, a head-mounted display (HMD), a virtual reality headset, and/or smart glasses. Display device 204 may include one or more cameras, including scene-facing cameras and/or user-facing cameras, a GPU, one or more sensors (e.g., such as one or more inertial measurement units (IMUs), image sensors, and/or microphones), and/or one or more output devices (e.g., such as speakers, headphones, displays, and/or smart glass). In other examples, display device 204 may include a handheld device with a display, such as a smartphone or tablet.

Processing device 206 may be, or may include, for example, a server computer (e.g., an edge or cloud-based server, a personal computer acting as a server device, or a mobile device acting as a server device). Processing device 206 may be configured to store virtual content and/or perform operations related to rendering the virtual content as image data suitable for providing to display device 204 for display. Companion device 208 may be, or may include, a smartphone, laptop, tablet computer, personal computer, gaming system, any other computing device and/or a combination thereof.

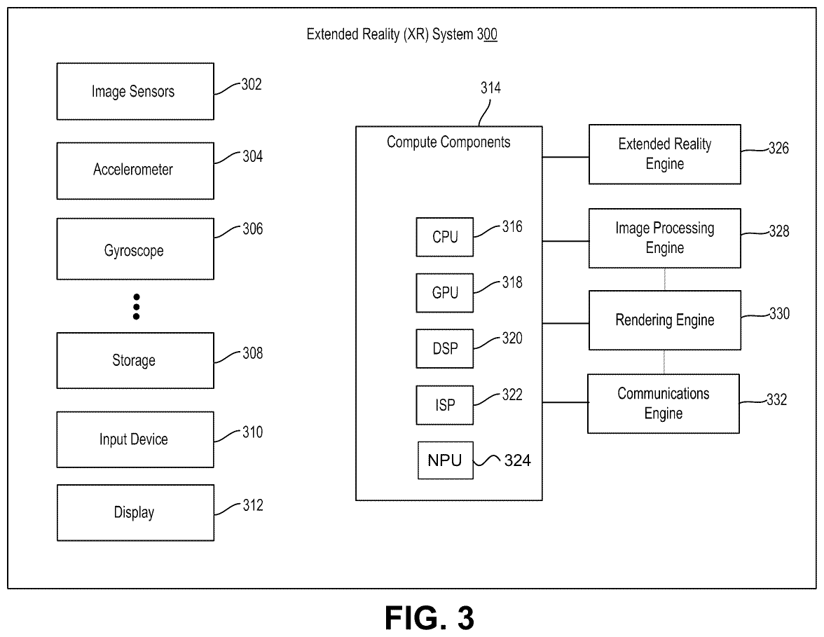

FIG. 3 is a diagram illustrating an architecture of an example extended reality (XR) system 300, in accordance with some aspects of the disclosure. XR system 300 may execute XR applications and implement XR operations. XR system 300 may be an example of, or be included in, any of XR device 104 of FIG. 1, display device 204 and/or companion device 208 of FIG. 2, and/or processing device 206 of FIG. 2.

In this illustrative example, XR system 300 includes one or more image sensors 302, an accelerometer 304, a gyroscope 306, storage 308, an input device 310, a display 312, Compute components 314, an XR engine 326, an image processing engine 328, a rendering engine 330, and a communications engine 332. It should be noted that the components 302-332 shown in FIG. 3 are non-limiting examples provided for illustrative and explanation purposes, and other examples may include more, fewer, or different components than those shown in FIG. 3. For example, in some cases, XR system 300 may include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 3. While various components of XR system 300, such as image sensor 302, may be referenced in the singular form herein, it should be understood that XR system 300 may include multiple of any component discussed herein (e.g., multiple image sensors 302).

Display 312 may be, or may include, a glass, a screen, a lens, a projector, and/or other display mechanism that allows a user to see the real-world environment and also allows XR content to be overlaid, overlapped, blended with, or otherwise displayed thereon.

XR system 300 may include, or may be in communication with, (wired or wirelessly) an input device 310. Input device 310 may include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensor 302 may capture images that may be processed for interpreting gesture commands.

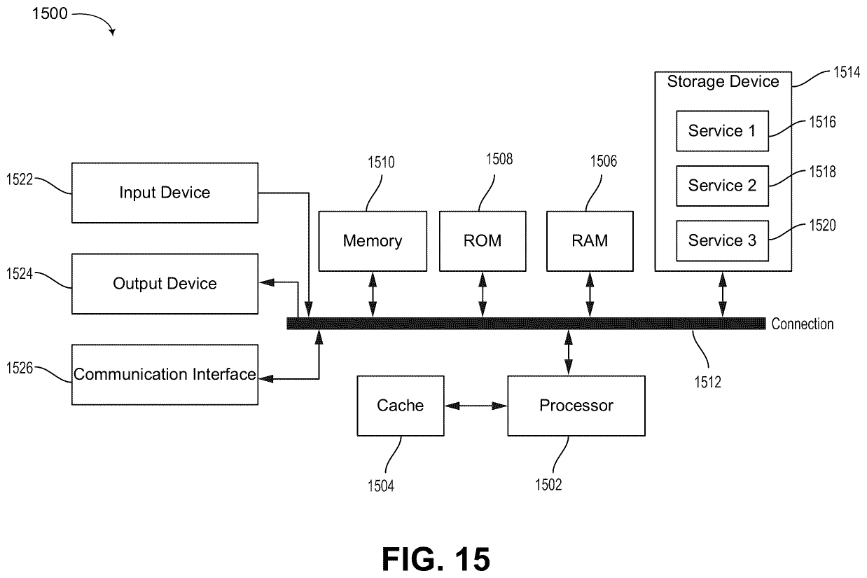

XR system 300 may also communicate with one or more other electronic devices (wired or wirelessly). For example, communications engine 332 may be configured to manage connections and communicate with one or more electronic devices. In some cases, communications engine 332 may correspond to communication interface 1526 of FIG. 15.

In some implementations, image sensors 302, accelerometer 304, gyroscope 306, storage 308, display 312, compute components 314, XR engine 326, image processing engine 328, and rendering engine 330 may be part of the same computing device. For example, in some cases, image sensors 302, accelerometer 304, gyroscope 306, storage 308, display 312, compute components 314, XR engine 326, image processing engine 328, and rendering engine 330 may be integrated into an HMD, extended reality glasses, smartphone, laptop, tablet computer, gaming system, and/or any other computing device. However, in some implementations, image sensors 302, accelerometer 304, gyroscope 306, storage 308, display 312, compute components 314, XR engine 326, image processing engine 328, and rendering engine 330 may be part of two or more separate computing devices. For instance, in some cases, some of the components 302-332 may be part of, or implemented by, one computing device and the remaining components may be part of, or implemented by, one or more other computing devices. For example, such as in a split perception XR system, XR system 300 may include a first device (e.g., an HMD), including display 312, image sensor 302, accelerometer 304, gyroscope 306, and/or one or more compute components 314. XR system 300 may also include a second device including additional compute components 314 (e.g., implementing XR engine 326, image processing engine 328, rendering engine 330, and/or communications engine 332). In such an example, the second device may generate virtual content based on information or data (e.g., images, sensor data such as measurements from accelerometer 304 and gyroscope 306) and may provide the virtual content to the first device for display at the first device. The second device may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 308 may be any storage device(s) for storing data. Moreover, storage 308 may store data from any of the components of XR system 300. For example, storage 308 may store data from image sensor 302 (e.g., image or video data), data from accelerometer 304 (e.g., measurements), data from gyroscope 306 (e.g., measurements), data from compute components 314 (e.g., processing parameters, preferences, virtual content, rendering content, scene maps, tracking and localization data, object detection data, privacy data, XR application data, face recognition data, occlusion data, etc.), data from XR engine 326, data from image processing engine 328, and/or data from rendering engine 330 (e.g., output frames). In some examples, storage 308 may include a buffer for storing frames for processing by compute components 314.

Compute components 314 may be, or may include, a central processing unit (CPU) 316, a graphics processing unit (GPU) 318, a digital signal processor (DSP) 320, an image signal processor (ISP) 322, a neural processing unit (NPU) 324, which may implement one or more trained neural networks, and/or other processors. Compute components 314 may perform various operations such as image enhancement, computer vision, graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 314 may implement (e.g., control, operate, etc.) XR engine 326, image processing engine 328, and rendering engine 330. In other examples, compute components 314 may also implement one or more other processing engines.

Image sensor 302 may include any image and/or video sensors or capturing devices. In some examples, image sensor 302 may be part of a multiple-camera assembly, such as a dual-camera assembly. Image sensor 302 may capture image and/or video content (e.g., raw image and/or video data), which may then be processed by compute components 314, XR engine 326, image processing engine 328, and/or rendering engine 330 as described herein.

In some examples, image sensor 302 may capture image data and may generate images (also referred to as frames) based on the image data and/or may provide the image data or frames to XR engine 326, image processing engine 328, and/or rendering engine 330 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, image sensor 302 (and/or other camera of XR system 300) may be configured to also capture depth information. For example, in some implementations, image sensor 302 (and/or other camera) may include an RGB-depth (RGB-D) camera. In some cases, XR system 300 may include one or more depth sensors (not shown) that are separate from image sensor 302 (and/or other camera) and that may capture depth information. For instance, such a depth sensor may obtain depth information independently from image sensor 302. In some examples, a depth sensor may be physically installed in the same general location or position as image sensor 302 but may operate at a different frequency or frame rate from image sensor 302. In some examples, a depth sensor may take the form of a light source that may project a structured or textured light pattern, which may include one or more narrow bands of light, onto one or more objects in a scene. Depth information may then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

XR system 300 may also include other sensors in its one or more sensors. The one or more sensors may include one or more accelerometers (e.g., accelerometer 304), one or more gyroscopes (e.g., gyroscope 306), and/or other sensors. The one or more sensors may provide velocity, orientation, and/or other position-related information to compute components 314. For example, accelerometer 304 may detect acceleration by XR system 300 and may generate acceleration measurements based on the detected acceleration. In some cases, accelerometer 304 may provide one or more translational vectors (e.g., up/down, left/right, forward/back) that may be used for determining a position or pose of XR system 300. Gyroscope 306 may detect and measure the orientation and angular velocity of XR system 300. For example, gyroscope 306 may be used to measure the pitch, roll, and yaw of XR system 300. In some cases, gyroscope 306 may provide one or more rotational vectors (e.g., pitch, yaw, roll). In some examples, image sensor 302 and/or XR engine 326 may use measurements obtained by accelerometer 304 (e.g., one or more translational vectors) and/or gyroscope 306 (e.g., one or more rotational vectors) to calculate the pose of XR system 300. As previously noted, in other examples, XR system 300 may also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors may include at least one IMU. An IMU is an electronic device that measures the specific force, angular rate, and/or the orientation of XR system 300, using a combination of one or more accelerometers, one or more gyroscopes, and/or one or more magnetometers. In some examples, the one or more sensors may output measured information associated with the capture of an image captured by image sensor 302 (and/or other camera of XR system 300) and/or depth information obtained using one or more depth sensors of XR system 300.

The output of one or more sensors (e.g., accelerometer 304, gyroscope 306, one or more IMUs, and/or other sensors) can be used by XR engine 326 to determine a pose of XR system 300 (also referred to as the head pose) and/or the pose of image sensor 302 (or other camera of XR system 300). In some cases, the pose of XR system 300 and the pose of image sensor 302 (or other camera) can be the same. The pose of image sensor 302 refers to the position and orientation of image sensor 302 relative to a frame of reference (e.g., with respect to a field of view 110 of FIG. 1). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees of Freedom (3DoF), which refers to the three angular components (e.g. roll, pitch, and yaw).

In some cases, a device tracker (not shown) can use the measurements from the one or more sensors and image data from image sensor 302 to track a pose (e.g., a 6DoF pose) of XR system 300. For example, the device tracker can fuse visual data (e.g., using a visual tracking solution) from the image data with inertial data from the measurements to determine a position and motion of XR system 300 relative to the physical world (e.g., the scene) and a map of the physical world. As described below, in some examples, when tracking the pose of XR system 300, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of XR system 300 within the scene and the 3D map of the scene, etc. The 3D map can provide a digital representation of a scene in the real/physical world. In some examples, the 3D map can anchor position-based objects and/or content to real-world coordinates and/or objects. XR system 300 can use a mapped scene (e.g., a scene in the physical world represented by, and/or associated with, a 3D map) to merge the physical and virtual worlds and/or merge virtual content or objects with the physical environment.

In some aspects, the pose of image sensor 302 and/or XR system 300 as a whole can be determined and/or tracked by compute components 314 using a visual tracking solution based on images captured by image sensor 302 (and/or other camera of XR system 300). For instance, in some examples, compute components 314 can perform tracking using computer vision-based tracking, model-based tracking, and/or simultaneous localization and mapping (SLAM) techniques. For instance, compute components 314 can perform SLAM or can be in communication (wired or wireless) with a SLAM system (not shown). SLAM refers to a class of techniques where a map of an environment (e.g., a map of an environment being modeled by XR system 300) is created while simultaneously tracking the pose of a camera (e.g., image sensor 302) and/or XR system 300 relative to that map. The map can be referred to as a SLAM map and can be three-dimensional (3D). The SLAM techniques can be performed using color or grayscale image data captured by image sensor 302 (and/or other camera of XR system 300) and can be used to generate estimates of 6DoF pose measurements of image sensor 302 and/or XR system 300. Such a SLAM technique configured to perform 6DoF tracking can be referred to as 6DoF SLAM. In some cases, the output of the one or more sensors (e.g., accelerometer 304, gyroscope 306, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 302 (and/or other camera) to the SLAM map. For example, 6DoF SLAM can use feature point associations from an input image to determine the pose (position and orientation) of the image sensor 302 and/or XR system 300 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 302 and/or the XR system 300 can be determined by projecting features from the 3D SLAM map into an image or video frame and updating the camera pose from verified 2D-3D correspondences.

In one illustrative example, the compute components 314 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 314 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 300 can also track the hand and/or fingers of the user to allow the user to interact with and/or control virtual content in a virtual environment. For example, the XR system 300 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

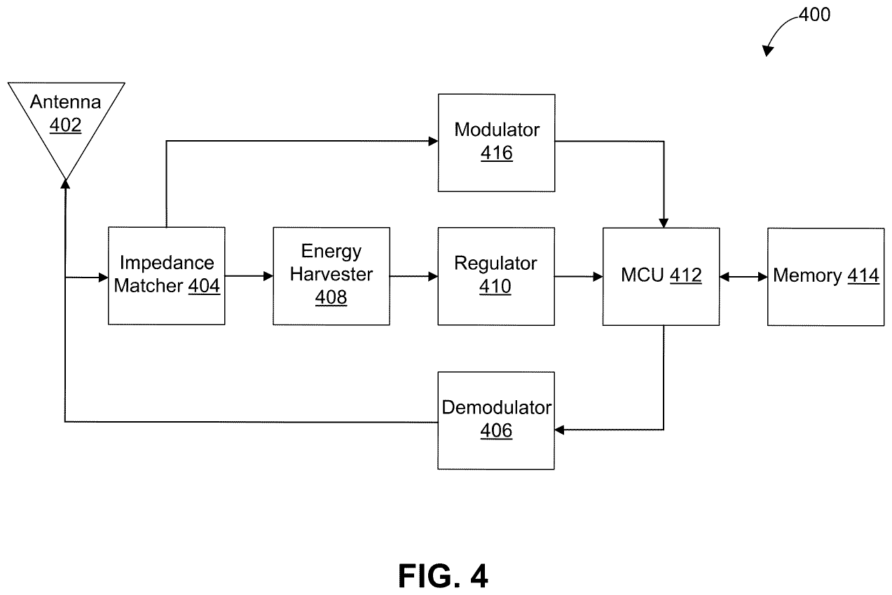

FIG. 4 is a block diagram illustrating a Radio-Frequency Identification (RFID) tag 400, according to various aspects of the present disclosure. In some aspects, RFID tag 400 may be a passive RFID tag or an active RFID tag. RFID tag 400 may include one or more antennae 402 that can be used to transmit and/or receive one or more wireless signals (e.g., to receive queries and to transmit responses). For example, RFID tag 400 can use antenna 402 to receive one or more downlink signals and to transmit one or more uplink signals. An impedance matcher 404 can be used to match the impedance of antenna 402 to the impedance of one or more (or all) of the receive components included in RFID tag 400. In some examples, the receive components of RFID tag 400 can include a demodulator 406 (e.g., for demodulating a received downlink signal), an energy harvester 408 (e.g., for harvesting RF energy from the received downlink signal), a regulator 410, a micro-controller unit (MCU) 412, a modulator 416 (e.g., for generating an uplink signal).

The downlink signals can be received from one or more transmitters. For example, RFID tag 400 may receive a downlink signal from an RFID reader. Additionally, or alternatively, RFID tag 400 may receive RF energy from other RF transmissions (e.g., ambient RF signals present in the environment).

RFID tag 400 can be implemented as a passive or semi-passive energy harvesting device, which perform passive uplink communication by modulating and reflecting a downlink signal received via antenna 402. For example, RFID tag 400 may receiving a downlink signal and modulated and reflected the downlink signal to generate and transmit an uplink signal.

In other examples, RFID tag 400 may be implemented as an active energy harvesting device, which utilizes a powered transceiver to perform active uplink communication. For example, RFID tag 400 may generate and transmit an uplink signal without first receiving a downlink signal (e.g., by using an on-device power source to energize its powered transceiver).

In cases in which RFID tag 400 is a passive energy harvesting device, RFID tag 400 may be powered using RF energy harvested from a downlink signal (e.g., using energy harvester 408). In cases in which RFID tag 400 is a semi-passive energy harvesting device, RFID tag 400 may include one or more energy storage elements (not illustrated in FIG. 4) (e.g., capacitors, ultracapacitors, or batteries) and/or other on-device power sources. The energy storage element of RFID tag 400 can be used to temporarily store, augment, or supplement the RF energy harvested from a downlink signal. The energy storage element(s) of RFID tag 400 can be charged using harvested RF energy. In some cases, the energy storage element may store insufficient energy to transmit an uplink communication without first receiving a downlink communication. In cases in which RFID tag 400 is an active energy harvesting device, RFID tag 400 can include one or more energy storage elements or other on-device power sources (not illustrated in FIG. 4) that can power uplink communication without using supplemental harvested RF energy.

As mentioned above, RFID tag 400 may transmit uplink communications by performing backscatter modulation to modulate and reflect a received downlink signal. The received downlink signal may be used to provide both electrical power (e.g., to perform demodulation, local processing, and modulation) and a carrier wave for uplink communication (e.g., the reflection of the downlink signal). For example, a portion of the downlink signal may be backscattered as an uplink signal and a remaining portion of the downlinks signal may be used to perform energy harvesting.

RFID tag 400, when implemented as an active energy harvesting device, can transmit uplink communications without performing backscatter modulation and without receiving a corresponding downlink signal (e.g., an active energy harvesting device includes an energy storage element to provide electrical power and includes a powered transceiver to generate a carrier wave for an uplink communication). In the absence of a downlink signal, passive and semi-passive energy harvesting devices may, or may not, be able to transmit an uplink signal (e.g., passive communication). Active energy harvesting devices do not depend on receiving a downlink signal in order to transmit an uplink signal and can transmit an uplink signal as desired (e.g., active communication).

In examples in which the RFID tag 400 is implemented as a passive or semi-passive energy harvesting device, a continuous carrier wave downlink signal may be received using antenna 402 and modulated (e.g., re-modulated) for uplink communication. In some cases, a modulator 416 can be used to modulate the reflected (e.g., backscattered) portion of the downlink signal. For example, the continuous carrier wave may be a continuous sinusoidal wave (e.g., sine or cosine waveform) and modulator 416 can perform modulation based on varying one or more of the amplitude and the phase of the backscattered reflection. Based on modulating the backscattered reflection, modulator 416 can encode digital symbols (e.g., such as binary symbols or more complex systems of symbols) indicative of an uplink communication or data message. For example, the uplink communication may be indicative of an identifier associated with the RFID tag 400.

As mentioned previously, impedance matcher 404 can be used to match the impedance of antenna 402 to the receive components of RFID tag 400 when receiving the downlink signal (e.g., when receiving the continuous carrier wave). In some examples, during backscatter operation (e.g., when transmitting an uplink signal), modulation can be performed based on intentionally mismatching the antenna input impedance to cause a portion of the incident downlink signal to be scattered back. The phase and amplitude of the backscattered reflection may be determined based on the impedance loading on the antenna 402. Based on varying the antenna impedance (e.g., varying the impedance mismatch between antenna 402 and the remaining components of RFID tag 400), digital symbols and/or binary information can be encoded (e.g., modulated) onto the backscattered reflection. Varying the antenna impedance to modulate the phase and/or amplitude of the backscattered reflection can be performed using modulator 416.

As illustrated in FIG. 4, a portion of a downlink signal received using antenna 402 can be provided to a demodulator 406, which performs demodulation and provides a downlink communication (e.g., carried or modulated on the downlink signal) to MCU 412 or other processor included in the RFID tag 400. A remaining portion of the downlink signal received using antenna 402 can be provided to energy harvester 408, which harvests RF energy from the downlink signal. For example, energy harvester 408 can harvest RF energy based on performing AC-to-DC (alternating current-to-direct current) conversion, wherein an AC current is generated from the sinusoidal carrier wave of the downlink signal and the converted DC current is used to power the RFID tag 400. In some aspects, energy harvester 408 can include one or more rectifiers for performing AC-to-DC conversion. A rectifier can include one or more diodes or thin-film transistors (TFTs). In one illustrative example, energy harvester 408 can include one or more Schottky diode-based rectifiers. In some cases, energy harvester 408 can include one or more TFT-based rectifiers.

The output of the energy harvester 408 is a DC current generated from (e.g., harvested from) the portion of the downlink signal provided to the energy harvester 408. In some aspects, the DC current output of energy harvester 408 may vary with the input provided to the energy harvester 408. For example, an increase in the input current to energy harvester 408 can be associated with an increase in the output DC current generated by energy harvester 408. In some cases, MCU 412 may be associated with a narrow band of acceptable DC current values. Regulator 410 can be used to remove or otherwise decrease variation(s) in the DC current generated as output by energy harvester 408. For example, regulator 410 can remove or smooth spikes (e.g., increases) in the DC current output by energy harvester 408 (e.g., such that the DC current provided as input to MCU 412 by regulator 410 remains below a first threshold). In some cases, regulator 410 can remove or otherwise compensate for drops or decreases in the DC current output by energy harvester 408 (e.g., such that the DC current provided as input to MCU 412 by regulator 410 remains above a second threshold).

In some aspects, the harvested DC current (e.g., generated by energy harvester 408 and regulated upward or downward as needed by energy harvester 408) can be used to power MCU 412 and one or more additional components included in the RFID tag 400. For example, the harvested DC current can additionally be used to power one or more (or all) of the impedance matcher 404, demodulator 406, regulator 410, MCU 412, memory 414, modulator 416, etc. For example, memory 414 and modulator 416 can receive at least a portion of the harvested DC current that remains after MCU 412 (e.g., that is not consumed by MCU 412). In some cases, the harvested DC current output by regulator 410 can be provided to MCU 412, and modulator 416, in series, in parallel, or a combination thereof.

RFID tag 400 may include a memory 414 which may be, or may include, a circuit or chip (e. g, a random-access memory (RAM), a field-programmable gate array (FPGA), and/or a circuit including static elements, for example, fuses) configured to store an identifier of RFID tag 400. RFID tag 400 may respond to queries (e.g., electromagnetic query pulses) with an uplink signal encoding the identifier. For example, RFID tag 400 may receive a query at antenna 402 and harvest energy from the query (and/or other ambient RF energy) at energy harvester 408. RFID tag 400 may activate demodulator 406 and MCU 412 to de-encode the query. MCU 412 may determine an appropriate response to the query. The response may be, or may include, the identifier of RFID tag 400 (e.g., the identifier stored in memory 414). MCU 412 and/or modulator 416 may generate the determined response and antenna 402 may transmit the determined response (e.g., through a backscattered reflection).

In some cases, RFID tag 400 may receive instructions (e.g., from an RFID reader). The instructions may alter the way RFID tag 400 responds to queries. For example, according to various aspects described herein, the instructions may instruct RFID tag 400 to respond to queries using a different identifier than the original identifier stored at memory 414. In such cases, the instructions may include the different identifier and RFID tag 400 may store the different identifier at memory 414. As another example, the instructions may instruct RFID tag 400 not to respond to queries. In such cases, RFID tag 400 may record an operating instruction or flag in memory 414 (or in MCU 412) such that RFID tag 400 will not respond to queries (e.g., until further instructions are provided).

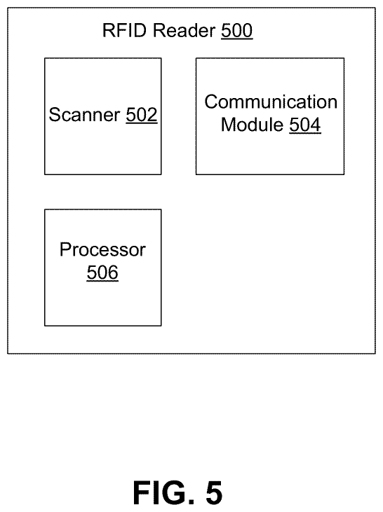

FIG. 5 is a block diagram illustrating an example RFID reader 500, according to various aspects of the present disclosure. RFID reader 500 may be part of an RFID tracking system. As shown, RFID reader 500 may include a scanner 502 to transmit queries and receive responses (e.g., from one or more RFID tags). In some cases, a query may be implemented as the downlink signal as described with regard to RFID tag 400. A response may be implemented as the uplink signal as described with regard to RFID tag 400.

RFID reader 500 may include a communication module 504 to communicate with other elements of an RFID tracking system. Communication module 504 may be configured to communicate according to any suitable wired or wireless communication protocol including, as examples, cellular long-term evolution (LTE) user-equipment-to-user-equipment (Uu), sidelink communications, and Institute of Electrical and Electronics Engineers (IEEE) 802.11 (Wi-Fi). RFID reader 500, through communication module 504, may communicate with one or more other RFID readers of an RFID tracking system (e.g., directly or through a network). Additionally, or alternatively, RFID reader 500, through communication module 504, may communicate with a controller of the RFID tracking system.

RFID reader 500 may include a processor 506. In some cases, the processor 506 can process information, such as one or more responses from one or more RFID tags as described herein.

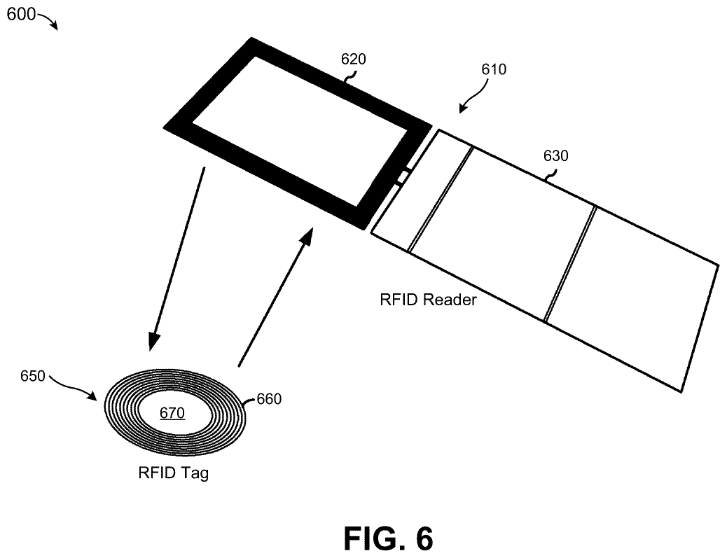

FIG. 6 is a diagram illustrating an example RFID system 600 that includes an RFID reader (e.g., energizer) 610 and an RFID tag 650. RFID reader 610 may also be referred to as an interrogator, a scanner, an energizer, etc. RFID tag 650 may also be referred to as an RFID label, an electronics label, etc.

RFID reader 610 includes an antenna 620 and an electronics unit 630. Antenna 620 radiates signals transmitted by RFID reader 610 and receives signals from RFID tags (e.g., such as the RFID tag 650) and/or other devices. Electronics unit 630 may include a transmitter and a receiver for reading RFID tags such as RFID tag 650. The same pair of transmitter and receiver (or another pair of transmitter and receiver) may support bi-directional communication with wireless networks, wireless devices, etc. In some examples, a first RFID reader or RFID device can include a transmitter for energizing one or more RFID tags, and a second RFID reader or RFID device can include a receiver for receiving the reflected signals from the one or more RFID tags. For instance, an RFID reader can be configured to implement energizing and tag reading capabilities (e.g., includes a transmitter and a receiver), can be configured to implement energizing capabilities (e.g., includes a transmitter), and/or can be configured to implement tag reading capabilities (e.g., includes a receiver). The electronics unit 630 may include processing circuitry (e.g., a processor) to perform processing for data being transmitted and received by RFID reader 610.

RFID tag 650 includes an antenna 660 and a data storage element 670. Antenna 660 radiates signals transmitted by RFID tag 650 and receives signals from RFID reader 610 and/or other devices. For instance, RFID tags can be passive, active, or semi-active. Passive RFID tags utilize the interrogating signal from an RFID reader to power a transmission by or from the RFID tag. Active and semi-active RFID tags can include a power source or battery, which can be used to power a transmission by or from the RFID tag. In some examples, the RFID tag 650 may be a passive RFID tag having no battery. In this case, a magnetic field from a signal transmitted by RFID reader 610 (e.g., an energizing or interrogating signal from the RFID reader 610) may induce an electrical current in RFID tag 650, which may then operate based on the induced current. RFID tag 650 can radiate its signal in response to receiving a signal from RFID reader 610 or some other device.

The RFID tag 650 can use the data storage element 670 to store identification information corresponding to the RFID tag 650 and/or corresponding to an item associated with the RFID tag 650 (e.g., an item to which the RFID tag 650 is attached, etc.). For example, data storage element 670 can be used to store identification information using various granularity levels for tracking and management of an RFID tagged item. An RFID tag attached to a respective item, or attached to a group of items, may store corresponding information thereof. For example, the RFID tag 650 can be configured to store, using data storage element 670, identification information corresponding to the item(s) to which the RFID tag 650 is attached and associated. For instance, RFID tag information can include one or more of a product name, a serial number, product information, a manufacturer, etc. In some examples, the RFID tag 650 can store (e.g., using the data storage element 670) identification information that is directly indicative of a tagged item, product, object, etc. For instance, the RFID tag 650 can store identification information such as a unique product serial number, etc. In some examples, the RFID tag 650 does not store product or item identification information directly, and stores a unique RFID tag serial number or identification number corresponding to the RFID tag 650, which may be externally mapped to various item identification information such as product serial numbers, product names, product SKUs, etc.

Data storage element 670 can be configured to store identification information for RFID tag 650, e.g., in an electrically erasable programmable read-only memory (EEPROM). RFID tag 650 may also include an electronics unit that can process the received signal and generate the signals to be transmitted.

RFID tag 650 may be read as follows. RFID reader 610 may be placed or moved within close proximity to RFID tag 650. RFID reader 610 may radiate a first signal (which is also called an interrogation signal) via its antenna 620. The energy of the first signal may be coupled from RFID reader antenna 620 to RFID tag antenna 660 via magnetic coupling and/or other phenomena. RFID tag 650 may receive the first signal from RFID reader 610 via antenna 660 and, in response, may radiate a second signal (which is also referred to as a responding signal) comprising the information stored in data storage element 670. RFID reader 610 may receive the second signal from RFID tag 650 via antenna 620 and may process the received signal to obtain the information sent in the second signal.

RFID system 600 may be designed to operate at 33.56 MHz or some other frequency. RFID reader 610 may have a specified maximum transmit power level, which may be imposed by the Federal Communication Commission (FCC) in the United Stated or other regulatory bodies in other countries. The specified maximum transmit power level of RFID reader 610 limits the distance at which RFID tag 650 can be read by RFID reader 610.

As noted previously, the systems and techniques described herein can be used to perform selective reading of RFID tags and RFID tag identification information corresponding to collected items of a shopper's basket (e.g., also referred to as “basket contents”). The systems and techniques can perform selective RFID tag reading without using configuration information that is indicative of a first subset of RFID tags that are of interest and/or that is indicative of a second subset of RFID tags that are not of interest. The systems and techniques can be used to obtain RFID tag identification information corresponding to a shopper's basket contents based on a time series and/or location-based analysis of RFID tag identification information obtained from a plurality of RFID tags attached to products in a store or retail environment. In some aspects, selective reading of RFID tags can be implemented without using modified antenna configurations for RFID readers (e.g., energizers) used to interrogate and scan the RFID tags. For instance, the systems and techniques can be used to determine a shopper's basket contents without narrowing or confining the energizing of RFID tags to the physical confines or limits of the shopper's basket.

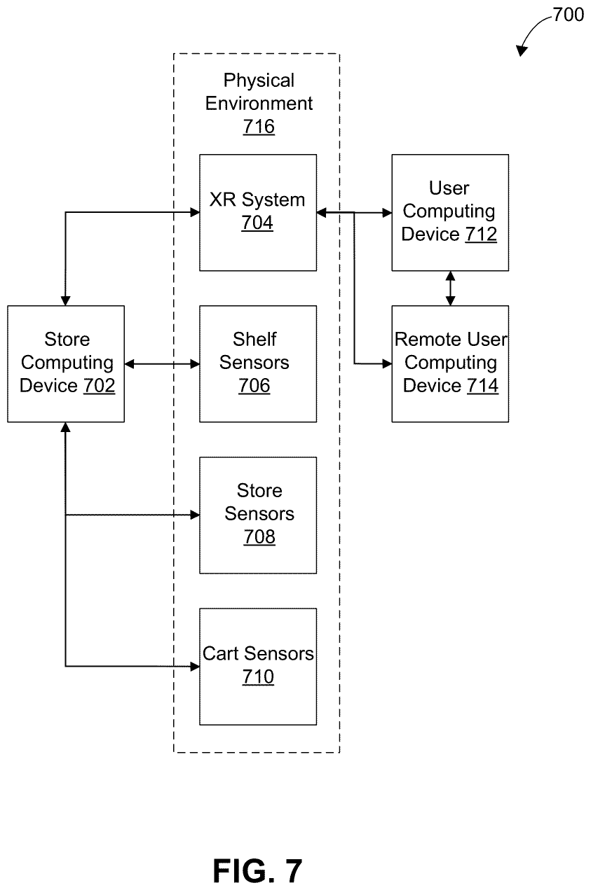

FIG. 7 is a block diagram of an example system 700 for assisted searching in a physical environment 716, according to various aspects of the present disclosure. In general, a user may user an XR system 704 in physical environment 716. Physical environment 716 may include a number of sensors, such as shelf sensors 706, store sensors 708, and cart sensors 710. Behavior of the user in physical environment 716 may be detected, determined tracked, analyzed, stored, etc. based on data from XR system 704, shelf sensors 706, store sensors 708, and cart sensors 710. Additionally, information may be presented to the user (e.g., via XR system 704) based on the user's behavior.

XR system 704 may be an example of XR system 100 of FIG. 1, XR system 200 of FIG. 2, and/or XR system 300 of FIG. 3. XR system 704 may include a display that can display virtual content to a user. Additionally, XR system 704 may include one or more scene-facing cameras to capture images of physical environment 716. Additionally, XR system 704 may include one or more user-facing cameras to capture images of a face (including eyes) of the user. In some aspects, XR system 704 may determine a gaze of the user based on images captured images of the face of the user. Further, XR system 704 may determine objects the user is gazing at in physical environment 716 based on images captured by the scene-facing cameras and images captured by the user-facing cameras.

Shelf sensors 706 may detect movement of objects relative to shelves or displays in physical environment 716. Shelf sensors 706 may be affixed to shelves or displays in physical environment 716. Shelf sensors 706 may be, or may include, radio-frequency identifier (RFID) readers, electronic shelf label (ESL) readers, cameras, microphones, and/or pressure sensors. In some aspects, shelf sensors 706 may be configured to transmit object data responsive to the at least one sensor sensing that the user interacting with the object.

In some aspects, shelf sensors 706 may include one or more RFID readers such as RFID reader 500 of FIG. 5, and/or RFID reader 610 of FIG. 6. Objects (e.g., products) in physical environment 716 may include RFID tags, such as RFID tag 400 of FIG. 4 and/or RFID tag 650 of FIG. 6.

Store sensors 708 may include cameras positioned throughout physical environment 716. For example, store sensors 708 may include security cameras and/or cameras and/or microphones configured and positioned to track objects within physical environment 716. Store sensors 708 may be mounted on walls and/or a ceiling of XR content 116.

Cart sensors 710 may be, or may include, RFID readers positioned and configured to detect objects in a cart of a user of XR system 704. For example, cart sensors 710 may include one or more RFID readers such as RFID reader 500 of FIG. 5, and/or RFID reader 610 of FIG. 6.

For example, an XR shopping system (e.g., system 700) could integrate data from various in-store IOT devices (e.g., shelf sensors 706, store sensors 708, cart sensors 710) with data from XR system 704 and track real-time user shopping behavior (what items the user sees, what items the user handles, what parts of the item label the user looks at, and what items the user places in their cart, etc.). For instance, when a shopper browses items on a shelf, system 700 (e.g., using data from XR system 704) could track eye dwell time (e.g., how long the user spends looking particular items). Additionally, system 700 could track if the user picks an item off the shelf and how long the object has been off the shelf (e.g., using data from XR system 704, shelf sensors 706, and/or store sensors 708). Additionally, system 700 could track (e.g., using data from XR system 704) how long the user looks at a various parts of an object (e.g., a label) and/or what parts of the object the user looks at. System 700 could also track if the user places the item in their cart (e.g., using data from XR system 704 and/or cart sensors 710). In some aspects, system 700 may initiate a purchase via contactless payment.

All the inputs above could feed a purchase intention module which could push real-time personalized coupons, promos, recommendations, and other product info to XR system 704, for example, when a threshold of intention to purchase has been reached for a product or multiple products. For example, if a user looks at a product for 10 seconds, then picks the product up off the shelf and inspects a label of the product for 5 more seconds, this could trigger a 30% discount coupon to appear in an XR device of the user which may entice the user to purchase the product.

Additionally or alternatively, once items are placed in a shopping cart (e.g., as determined by XR system 704 and/or cart sensors 710), system 700 could update the user's shopping list and/or invoice/account in real-time. For example, the user may have a personal shopping list and/or personal shopping preferences stored at user computing device 712. In some aspects, XR system 704 may include user computing device 712. In some aspects, XR system 704 may be communicatively connected to user computing device 712.

If contactless payment is initiated by the user, when the user pushes the cart out of the store and confirms the purchase, the user may be billed for the items. Additionally, the store's inventory management system could be updated. Such experiences could be enabled via in-store IOT devices tied to the system.

For example, store computing device 702 may perform operations related to inventory management, product tracking, and/or payment management. Based on data from XR system 704, shelf sensors 706, store sensors 708, and/or cart sensors 710. For example, based on a determination that a user has removed an object from physical environment 716, store computing device 702 may update an inventory of the store and bill the user.

Additionally or alternatively, system 700 may include an XR Collaboration Module, for example. The XR collaboration module may be part of the larger XR/IOT shopping system. Alternatively, the XR collaboration module may stand alone.

The XR collaboration module may allow a remote (e.g., non-collocated) user to view (e.g., via a device of the remote user, such as remote user computing device 714, which may be, for example, a tablet, a phone, an XR device, etc.) what a local user (shopper) sees with their XR HMD. For example, XR system 704 may capture images (e.g., video) and transmit the images to remote user computing device 714. Additionally, the remote user may point, touch, gesture, circle, or speak to indicate an item of interest based on the images displayed at remote user computing device 714. Remote user computing device 714 may transmit the indication to XR system 704. XR system 704 may “highlighting” the item of interest in the local shopper's view, which enables the shopper to easily select the correct item. The “highlighted” item of interest may appear to glow on in the display of XR system 704. For example, a glow virtual effect may be anchored to the item of interest. For example, in the shopper's view the glow may appear to be “stuck” or locked to the item as the shopper looks and/or moves around. The glow may persist until the shopper places the item of interest in the shopper's cart.

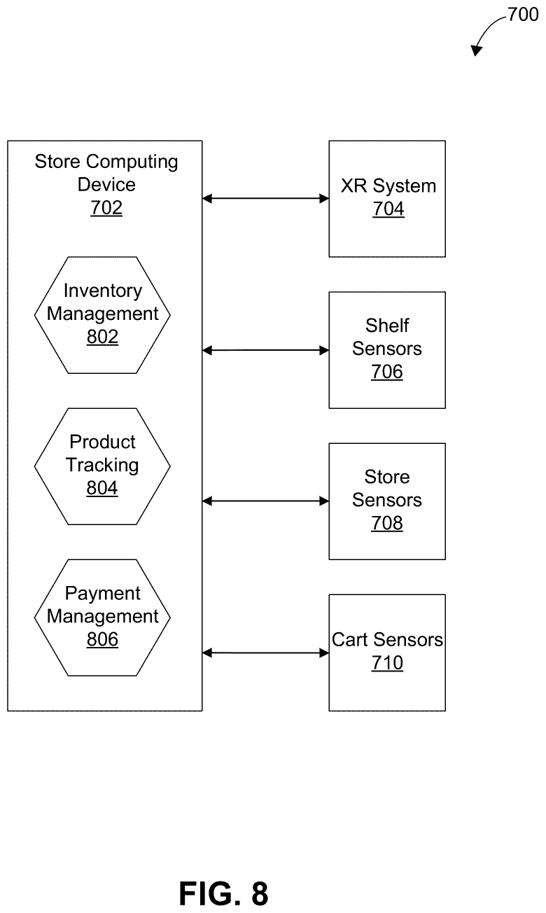

FIG. 8 is a block diagram illustrating various operations that may be performed by system 700, according to various aspects of the present disclosure. In some aspects, store computing device 702 may perform operations related to inventory management 802, product tracking 804, and/or payment management 806. Based on data from XR system 704, shelf sensors 706, store sensors 708, and/or cart sensors 710. For example, based on a determination that a user has removed an object from physical environment 716 (e.g., based on data from XR system 704, store sensors 708, and/or cart sensors 710), store computing device 702 may update an inventory of the store and bill the user.

In some aspects, XR system 704 may provide data to store computing device 702. For example, in some aspects, XR system 704 may provide image data and/or indications that XR system 704 has made relative to products (for example, an indication that XR system 704 has placed a product in a cart of the user).

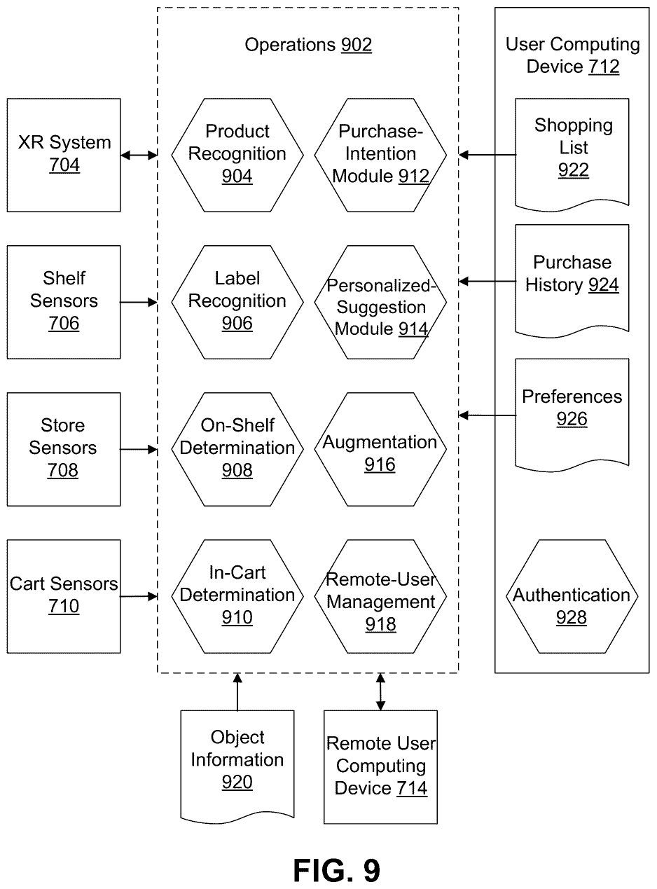

FIG. 9 is a block diagram illustrating various operations 902 that may be performed by system 700, according to various aspects of the present disclosure. Operations 902 may include any or all of product recognition 904, label recognition 906, on-shelf determination 908, in-cart determination 910, purchase-intention module 912, personalized-suggestion module 914, augmentation 916, and/or remote-user management 918. Any or all of operations 902 may be performed by store computing device 702, by XR system 704, by user computing device 712, or by another computing device (e.g., a remote server). For example, in some aspects, store computing device 702 may perform in-cart determination 910 based on data from cart sensors 710. Additionally or alternatively, XR system 704 may perform in-cart determination 910 based on image data captured by XR system 704.

Store computing device 702 may perform one or more of the operations described with regard to FIG. 8 based on outputs and/or determinations of operations 902 of FIG. 9. For example, payment management 806 may bill a user based on a determination from in-cart determination 910.

XR system 704 may display information to a user based on outputs and/or determinations of operations 902. For example, XR system 704 may display object information to a user based on outputs of purchase-intention module 912 and personalized-suggestion module 914.

Product recognition 904 may involve recognizing a product that a user is looking at and/or interacting with. Product recognition 904 may determine that a user is looking at and/or interacting with (e.g., holding) a product based on image data from XR system 704, sensor data from shelf sensors 706, and/or sensor data from store sensors 708 (e.g., video data).

Label recognition 906 may involve determining that a user is looking at a particular portion of an object (e.g., a product label). Label recognition 906 may determine that the user is looking at the particular portion based on image data from XR system 704.

On-shelf determination 908 may involve determining that a user is interacting with an object (e.g., the user has removed the object from a shelf or the user has replaced the object on the shelf). On-shelf determination 908 may determine that the user is interacting with the object based on image data from XR system 704, data from shelf sensors 706, and/or data from store sensors 708.

In-cart determination 910 may involve determining that a user has placed an object in the user's cart. In-cart determination 910 may determine that the user has placed the object in the user's cart based on image data from XR system 704, data from store sensors 708, and/or data from cart sensors 710.

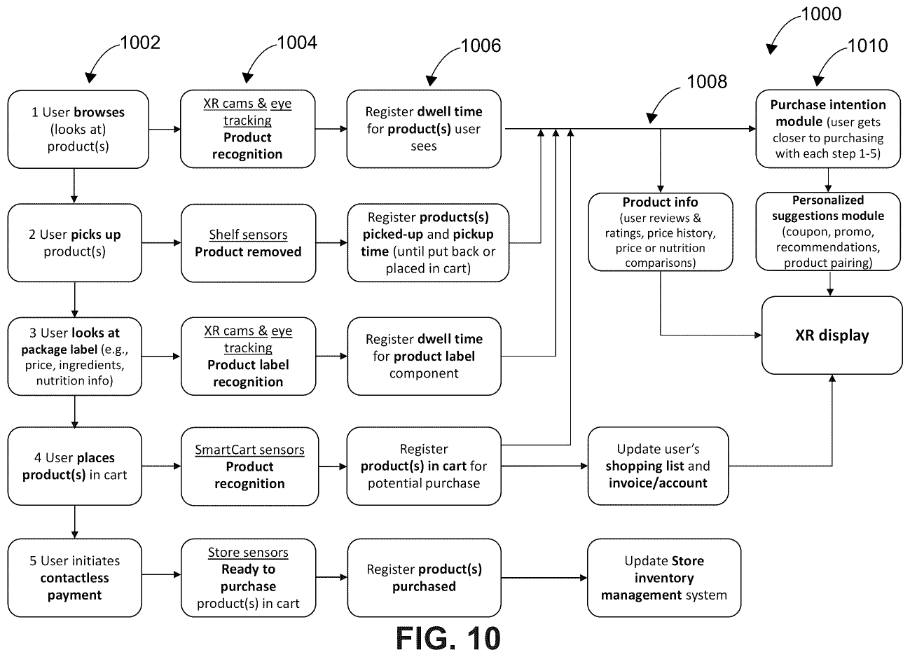

Purchase-intention module 912 may determine object information 920 to display to a user (and/or whether to display object information 920) based on interactions of the user with an object. For example, purchase-intention module 912 may, based on determinations based by product recognition 904, label recognition 906, on-shelf determination 908, and/or in-cart determination 910, determine object information 920 to display to the user. For example, based on a user looking at a product (e.g., as identified by product recognition 904), and based on the user lifting the object off a shelf (e.g., as determined by on-shelf determination 908), purchase-intention module 912 may determine to display object information 920 to the user. Additional detail regarding an example algorithm for determining information to display is provided with regard to FIG. 10.

Object information 920 may be, or may include, an indication of a value (e.g., price) of the object, an indication of a discount related to the object, an indication of a promotion related to the object (e.g., buy one get one free, or buy one product get a related product at a discount), a recommendation regarding the object, a recommendation regarding another object (e.g., buy this product with another product), user reviews of the object, a value (e.g., price) history of the object, nutritional facts related to the object, or specifications of the object. In some aspects, purchase-intention module 912 may determine what object information 920 to display to the user. Further, in some aspects, purchase-intention module 912 may determine what object information 920 to display to the user based on the user's interactions with the object. For example, if the user handles the object (e.g., as determined by product recognition 904) or looks at a label of the product (e.g., as determined by label recognition 906), purchase-intention module 912 may determine to display user reviews of the object. If the user replaces the object on a shelf (e.g., as determined by on-shelf determination 908), purchase-intention module 912 may determine to display a discount for the object.

Object information 920 may be obtained from store computing device 702 and/or from another source, such as the internet. For example, store computing device 702 may provide a current price of the product and customer reviews of the product may be obtained from the internet.

Personalized-suggestion module 914 may involve personalizing information to display to the user. For example, personalized-suggestion module 914 may determine object information 920 to display based on a shopping list 922 of the user, a purchase history 924 of the user, and/or preferences 926 of the user. For example, personalized-suggestion module 914 may determine to display information regarding a current promotion for a given product based on the user having purchased the product (or a competing product) in the past. Additionally or alternatively, personalized-suggestion module 914 may determine to display specification information to a user based on the user having searched for product specifications in the past.

Augmentation 916 may involve determining how to display object information 920 to the user. In some aspects, augmentation 916 may anchor object information 920 to the object in the view of the user.

Remote-user management 918 may involve a communicative connection between XR system 704 and remote user computing device 714. Remote-user management 918 may involve sending image data from XR system 704 to remote user computing device 714. Additionally or alternatively, remote-user management 918 may involve displaying the image data at remote user computing device 714. Additionally or alternatively, remote-user management 918 may involve allowing the remote user to provide inputs regarding the displayed image data (e.g., indicating an object). Additionally or alternatively, remote-user management 918 may involve causing augmentation 916 to display virtual content relative to the object indicated by the remote user. In some aspects, the virtual content (e.g., a glow, a circle, a color change, etc.) may be anchored to the indicated object in the field of view of the user (by XR system 704). Authentication 928 may authenticate user computing device 712 with store computing device 702 and/or remote user computing device 714.

FIG. 10 is a diagram illustrating an example scenario 1000 to illustrate various operations (e.g., of operations 902) that may be performed according to various aspects of the present disclosure. The left-most column of the diagram of FIG. 10 describes events 1002 (e.g., describing a user's interaction with a product). The second-from-the-left column in the diagram of FIG. 10 describes sensors that may detect events 1002. Additionally, the second-from-the-left column in the diagram of FIG. 10 describes operations 1004 that may make determinations based on events 1002. The third-from-the-left column in the diagram of FIG. 10 describes outputs 1006, outcomes, or results of operations (e.g., operations 1004). The fourth-from-the-left column in the diagram of FIG. 10 describes additional operations 1008 that may operate and/or be affected based on outputs 1006. The fifth-from-the-left column in the diagram of FIG. 10 describes additional operations 1010 that may operate and/or be affected based on outputs 1006 and/or operations 1008.

As an example, following a first row of the diagram of FIG. 10, a user may look at a product. Based on cameras (e.g., a user-facing camera and a scene-facing camera) of an XR device (e.g., XR system 704) product recognition 904 may determine that the user is looking at the product. Additionally, product recognition 904 may determine how long the user looks at the product. Additionally or alternatively, product recognition 904 may track the frequency and/or duration of discrete gazes. In some aspects, following the right-most column of FIG. 10, purchase-intention module 912 may determine to display object information 920 regarding the product based on how long the user looks at the product and/or based on a number of frequency of discrete gazes at the product.

Continuing the example, following a second row of the diagram of FIG. 10, the user may pick up the product. Shelf sensors 706 may sense that the product has been moved. On-shelf determination 908 may determine that the product has been moved (e.g., based on data from shelf sensors 706 and/or image data from XR system 704).

In some aspects, shelf sensors 706 may send object data, such as an object identifier, a universal product code (UPC), a stock keeping unit (SKU), and/or a value (e.g., price) of the object to XR system 704. XR system 704 may determine and/or obtain (e.g., from store computing device 702 or the internet) object information 920 based on the object data. Additionally, on-shelf determination 908 may track a time that the user holds the product.

In some aspects, following the right-most column of FIG. 10, purchase-intention module 912 may determine to display object information 920 regarding the product based on how long the user looks at the product, if the user picks the product up, and/or based on how long the user holds the product.

Continuing the example, following a third row of the diagram of FIG. 10, the user may look at a label of the product. Label recognition 906 may determine (e.g., based on image data from XR system 704) that the user is looking at the label. Additionally, label recognition 906 may determine how long the user looks at the label and/or which portions of the label the user looks at. In some aspects, following the right-most column of FIG. 10, purchase-intention module 912 may determine to display object information 920 regarding the product based on how long the user looks at the product, if the user picks the product up, how long the user holds the product, if the user looks at the label, and/or based on how long the user looks at the label.

Continuing the example, following a fourth row of the diagram of FIG. 10, the user may place the product in their cart. In-cart determination 910 may determine (e.g., based on image data from XR system 704 and/or data from cart sensors 710) that the user has placed the product in their cart. In some aspects, following the right-most column of FIG. 10, purchase-intention module 912 may determine to display object information 920 regarding the product based on how long the user looks at the product, if the user picks the product up, how long the user holds the product, if the user looks at the label, based on how long the user looks at the label and/or if the user placed the product in their cart. If the user placed the product in their cart, the user's shopping list 922 may be updated. In some aspects, if the shopping list 922 is updated, the updated shopping list 922 may be displayed to the user.

Continuing the example, following a fifth row of the diagram of FIG. 10, the user may initiate a payment for the product. Store sensors 708 may register the payment and that the product is in the cart. Inventory management 802 may update the store's inventory.

In some aspects, how purchase-intention module 912 determines whether to display object information 920 and/or which object information 920 to display may be determined by an owner of physical environment 716, an owner of the product, a manufacturer of the product, personal settings of XR system 704, or some other party. Purchase-intention module 912 may implement an algorithm to determine whether to display object information 920 and/or which object information 920 to display based on outputs of any or all of operations 902.

In some aspects, in the right-most column of the diagram of FIG. 10, personalized-suggestion module 914 may determine which object information 920 to display and/or how to display the determined object information 920. For example, personalized-suggestion module 914 may determine which object information 920 to display based on current products user is interested in, past purchase behavior, and store inventories.

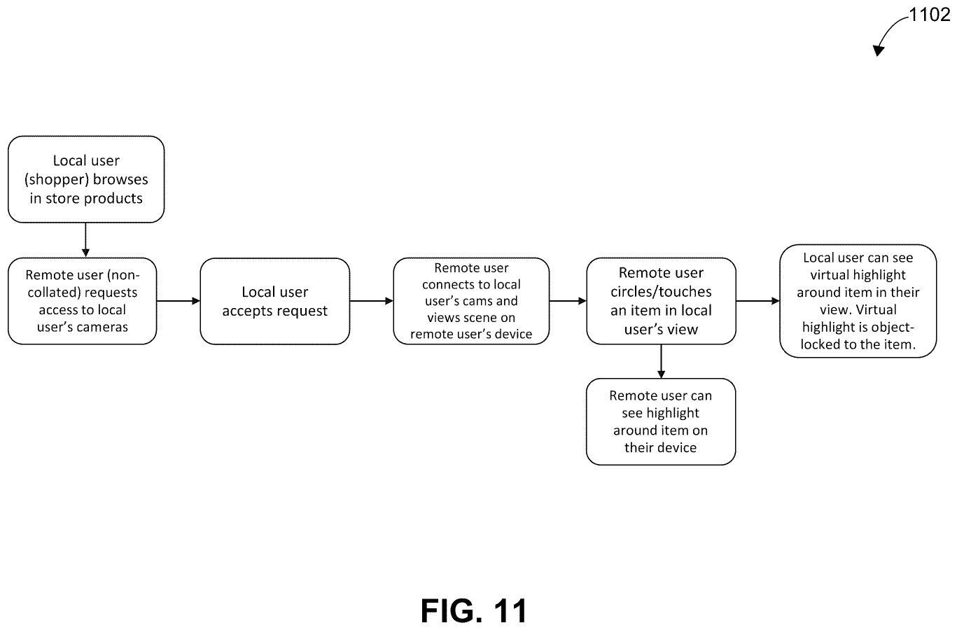

FIG. 11 is a diagram illustrating an example scenario 1102 to illustrate various operations (e.g., of remote-user management 918) that may be performed according to various aspects of the present disclosure. Scenario 1102 relates to an XR Collaboration Module. The XR A collaboration module may allow a non-collocated remote user to see (e.g., via tablet, phone, XR device, etc.) what a local user (shopper) sees with their XR HMD, allowing the remote user to point, touch, gesture, circle, or speak to indicate an item of interest via “highlighting” it in the shopper's view, which enables the shopper to easily select the correct item.

For example, the system 700 may enable and/or enhance interactions between an XR user in physical environment 716 and a remote user. For example, one or more images (e.g., a video stream) from a camera of XR system 704 in physical environment 716 may be shared with the remote user (via remote user computing device 714). The remote user can view the one or more images using remote user computing device 714. The remote user can select (e.g., circle) an object they want in at least one of the images. Remote user computing device 714 may transmit an indication of the item to XR system 704. XR system 704 may then anchor virtual content (e.g., a circle, coloring, a glow) to the object in the display of the XR system 704 in the field of view of the user in physical environment 716. The XR user in the physical environment 716 can then buy or pick up that object.

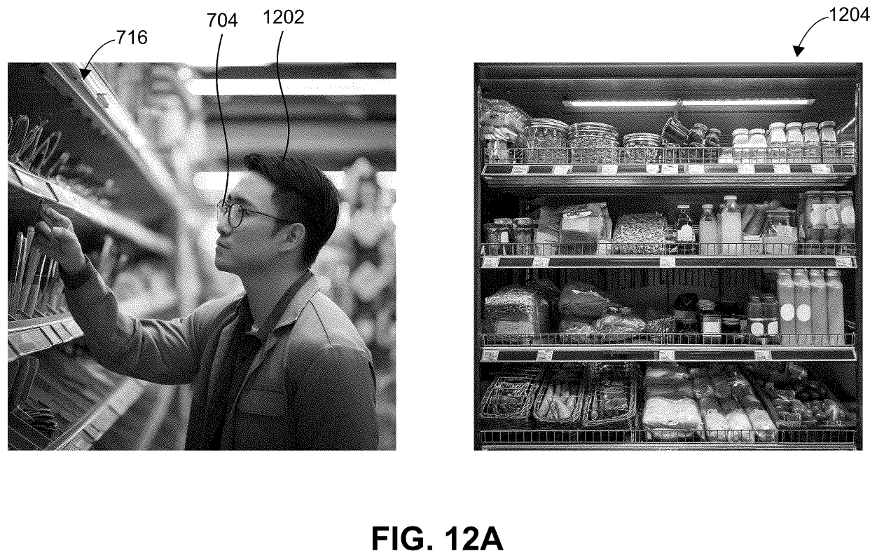

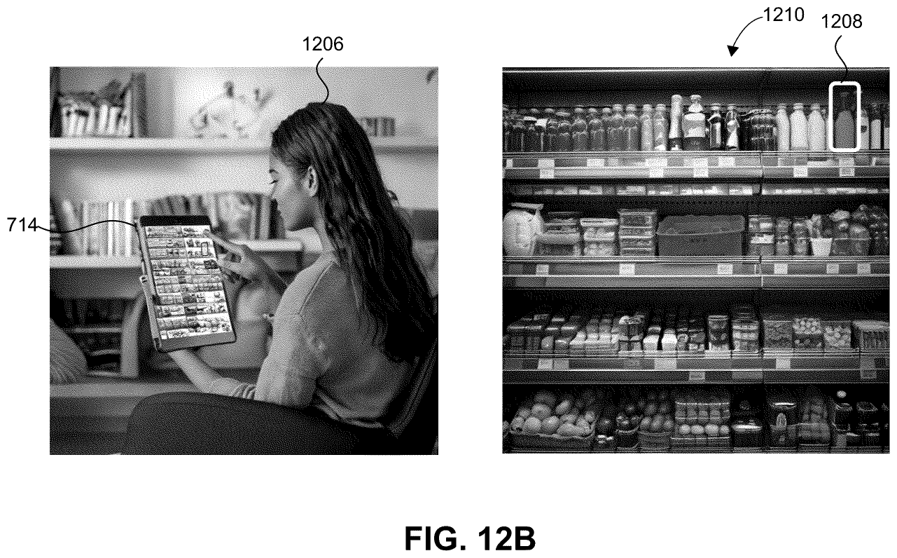

FIG. 12A and FIG. 12B include example images illustrating scenario 1102 of FIG. 11. User 1202 may use XR system 704 in physical environment 716. XR system 704 may capture image 1204 in physical environment 716. XR system 704 may transmit image 1204 to remote user computing device 714.

Remote user 1206 may view image 1204 at remote user computing device 714. Remote user 1206 may select an object in image 1204. Remote user computing device 714 may transmit an indication of the selected object to XR system 704.

XR system 704 may display virtual content 1208 to user 1202. For example, if XR system 704 is implementing a see-through display, XR system 704 may display virtual content 1208 anchored to the object selected by remote user 1206. If XR system 704 is implementing a video-see through or pass through display, XR system 704 may display image 1210 including virtual content 1208.

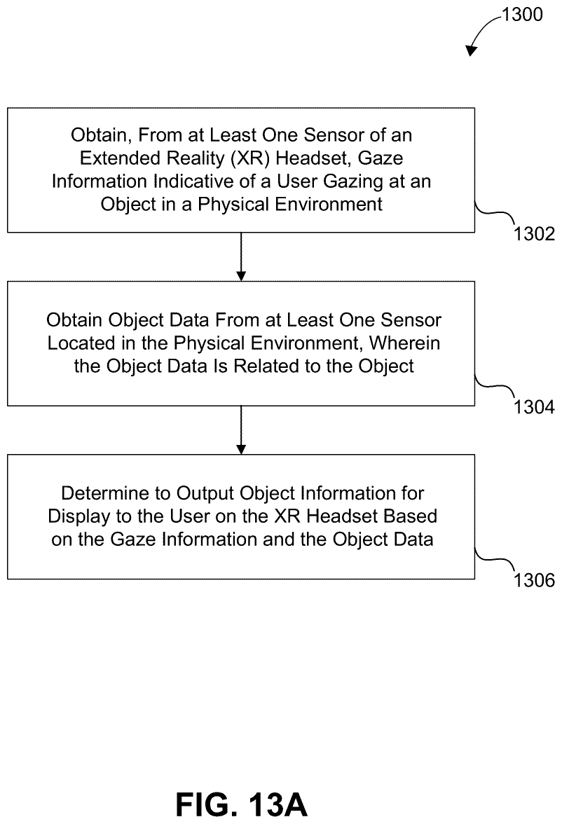

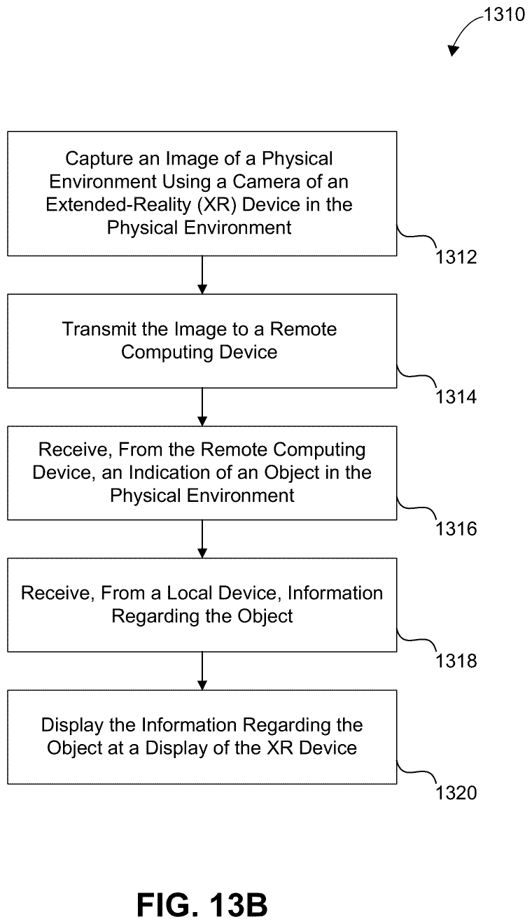

FIG. 13A is a flow diagram illustrating an example process 1300 for assisted searching, in accordance with aspects of the present disclosure. One or more operations of process 1300 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1300. The one or more operations of process 1300 may be implemented as software components that are executed and run on one or more processors.

At block 1302, a computing device (or one or more components thereof) may obtain, based on sensor data from at least one sensor of an extended reality (XR) headset, gaze information indicative of a user gazing at an object in a physical environment.

In some aspects, obtaining the gaze information may be, or may include, obtaining scene-facing images from a scene-facing camera of the XR headset; obtaining face images from a user-facing camera of the XR headset; and determining the gaze information based on the scene-facing images and the face images. For example, XR system 704 may include user-facing cameras that may capture face images of the user. XR system 704 may determine a gaze direction based on the face images. Additionally, XR system 704 may include scene-facing cameras that may capture images of the physical environment. XR system 704 may determine that the user is gazing at the object based on the images of the physical environment and the gaze direction. In some aspects, XR system 704 may use the gaze information, once obtained. In other aspects, XR system 704 may transmit the gaze information to store computing device 702 or another computing device.

At block 1304, the computing device (or one or more components thereof) may obtain object data from at least one sensor located in the physical environment, wherein the object data is related to the object.

In some aspects, the at least one sensor is configured to transmit the object data responsive to the at least one sensor sensing that the user interacting with the object. For example, shelf sensors 706, store sensors 708, and/or cart sensors 710 may be configured to transmit the object data responsive to the at least one sensor sensing that the user interacting with the object. For instance, shelf sensors 706 may be configured to transmit object information based on detecting that an object being lifted from a shelf. Store sensors 708 may be configured to transmit object information based on detecting that a user has picked up a product. Cart sensors 710 may be configured to transmit object information based on detecting that the user has placed an object in a cart.

In some aspects, the at least one sensor is configured to detect movement of the object. For example, shelf sensors 706, store sensors 708 and/or cart sensors 710 may be configured to detect movement of objects in the store (including the object that the user interacts with).

In some aspects, the at least one sensor comprises at least one of: a radio-frequency identifier (RFID) reader; an electronic shelf label (ESL) reader; a camera; a microphone; or a pressure sensor. For example, shelf sensors 706, store sensors 708 and/or cart sensors 710 may be, or may include, one or more RFID reads, one or more ESL readers, one or more cameras, one or more microphones, and/or one or more pressure sensors.

In some aspects, the at least one sensor is connected to at least one of: a shelf in a retail environment; a display in the retail environment; a wall in the retail environment; a ceiling in the retail environment; or a cart in the retail environment. For example, shelf sensors 706, store sensors 708 and/or cart sensors 710 may be connected to at least one of the at least one sensor is connected to at least one of: a shelf in a retail environment, a display in the retail environment, a wall in the retail environment, a ceiling in the retail environment, and/or a cart in the retail environment.

In some aspects, the object data comprises at least one of: an object identifier; a universal product code (UPC); a stock keeping unit (SKU); or a value of the object. For example, the object data obtained at block 1304 may be, or may include, an object identifier, a UPC, a SKU, and/or a value (e.g., price) of the object.

At block 1306, the computing device (or one or more components thereof) may determine to output object information for display to the user on the XR headset based on the gaze information and the object data.

In some aspects, the object information is determined to be presented to the user based on at least one of: a duration of time the user looks at the object; a number of times the user looks at the object; a portion of the object that the user looks at; a determination that the user is interacting with the object; a determination that the user is holding the object; a determination that the user is no longer holding the object; a determination that the user has replaced the object; a determination that the user has placed the object in a cart of the user ; or a determination that the user has taken the object out of the cart. For example, at block 1306, it may be determined that the object information is to be presented to the user based on, one or more of a duration of time the user looks at the object, a number of times the user looks at the object, a portion of the object that the user looks at, a determination that the user is interacting with the object, a determination that the user is holding the object, a determination that the user is no longer holding the object, a determination that the user has replaced the object, a determination that the user has placed the object in a cart of the user, and/or a determination that the user has taken the object out of the cart.

In some aspects, the object information may be, or may include, at least one of: an indication of a value of the object; an indication of a discount related to the object; an indication of a promotion related to the object; a recommendation regarding the object; a recommendation regarding another object; a comparison between the object and another object; user reviews of the object; user ratings of the object; a value history of the object; nutritional facts related to the object; or specifications of the object. For example, the object information determined to be presented to the user at block 1306 may be, or may include, an indication of a value (e.g., price) of the object, an indication of a discount related to the object, an indication of a promotion related to the object, a recommendation regarding the object, a recommendation regarding another object, a comparison between the object and another object, user reviews of the object, user ratings of the object, a value history (e.g., price history) of the object, nutritional facts related to the object; and/or specifications of the object.

In some aspects, the computing device (or one or more components thereof) may further comprising obtaining the object information based on the object data. For example, XR system 704 (or store computing device 702) may obtain the object information based on the object data. For instance, the object data may include an object identifier. XR system 704 (or store computing device 702) may obtain the object information based on the object identifier. For example, XR system 704 (or store computing device 702) may perform a search for the object information based on the object identifier.

In some aspects, the object information is obtained from: a server related to the physical environment; or the internet. For example, XR system 704 may obtain the object information from store computing device 702 or from the internet. As another example, store computing device 702 may obtain the object information from a server related to store computing device 702 or from the internet.

In some aspects, the computing device (or one or more components thereof) may display the object information to the user on the XR headset. For example, XR system 704 may display the object information.

In some aspects, the object may be a first object. The computing device (or one or more components thereof) may also receive an indication of a second object in the physical environment and anchor virtual content to the second object in a display of the XR headset. For example, XR system 704 may receive an indication of a second object in the physical environment and anchor virtual content to the second object.

In some aspects, the indication of the second object may be received from a remote user. For example, user 1202 may use XR system 704 in physical environment 716. XR system 704 may capture images of physical environment 716 and transmit the images to remote user computing device 714. Remote user computing device 714 may display the images of physical environment 716 captured by XR system 704 to remote user 1206. Remote user 1206 may select an object in an image of physical environment 716. XR system 704 may display virtual content 1208 anchored to the object selected by remote user 1206.

In some aspects, the computing device (or one or more components thereof) may transmit data from the at least one sensor of the XR headset to the remote user. For example, XR system 704 may transmit image data captured by scene-facing cameras of XR system 704 to remote user computing device 714.

For example, at block 1302, XR system 704 may determine gaze information indicative of a gaze of a user of XR system 704. XR system 704 may include user-facing cameras that may capture images including the eyes of the user (e.g., sensor data). XR system 704 may determine an object in the physical environment at which the user is gazing. XR system 704 may generate the gaze information to indicate the object at which the user is gazing. Continuing the example, at block 1304, a sensor, such as shelf sensors 706, store sensors 708, and/or cart sensors 710 may determine object data related to the object. Further, shelf sensors 706, store sensors 708, and/or cart sensors 710 may transmit the object information to XR system 704. Continuing the example, at block 1306, XR system 704 may determine object information to display at a display of XR system 704. Further XR system 704 may display the determined object information at the display of XR system 704.

As another example, at block 1302, store computing device 702 may obtain gaze information indicative of a gaze of a user of XR system 704. For instance, XR system 704 may include user-facing cameras that may capture images including the eyes of the user (e.g., sensor data). XR system 704 may determine an object in the physical environment at which the user is gazing. XR system 704 may generate the gaze information to indicate the object at which the user is gazing. Further, XR system 704 may transmit the gaze information to store computing device 702. Continuing the example, at block 1304, a sensor, such as shelf sensors 706, store sensors 708, and/or cart sensors 710 may determine object data related to the object. Further, shelf sensors 706, store sensors 708, and/or cart sensors 710 may transmit the object information to store computing device 702. Continuing the example, at block 1306, store computing device 702 may determine object information to display at a display of XR system 704. Further, store computing device 702 may transmit the determined object information to XR system 704 for display at a display of XR system 704.

As another example, at block 1302, a remote computing device (for example, a remote server associated with the store or a remote computing device associated with the user) may obtain gaze information indicative of a gaze of a user of XR system 704. For instance, XR system 704 may include user-facing cameras that may capture images including the eyes of the user (e.g., sensor data). XR system 704 may determine an object in the physical environment at which the user is gazing. XR system 704 may generate the gaze information to indicate the object at which the user is gazing. Further, XR system 704 may transmit the gaze information to remote computing device. Continuing the example, at block 1304, a sensor, such as shelf sensors 706, store sensors 708, and/or cart sensors 710 may determine object data related to the object. Further, shelf sensors 706, store sensors 708, and/or cart sensors 710 may transmit the object information the remote computing device. Continuing the example, at block 1306 the remote computing device may determine object information to display at a display of XR system 704. Further, the remote computing device may transmit the determined object information to XR system 704 for display at a display of XR system 704.

FIG. 13B is a flow diagram illustrating an example process 1310 for assisted searching, in accordance with aspects of the present disclosure. One or more operations of process 1310 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1310. The one or more operations of process 1310 may be implemented as software components that are executed and run on one or more processors.

At block 1312, a computing device (or one or more components thereof) may capture an image of a physical environment using a camera of an extended-reality (XR) device in the physical environment. For example, XR system 704 may capture image 1204 a physical environment of user 1202.

At block 1314, the computing device (or one or more components thereof) may transmit the image to a remote computing device. For example, XR system 704 may transmit image 1204 to remote user computing device 714.

At block 1316, the computing device (or one or more components thereof) may receive, from the remote computing device, an indication of an object in the physical environment. For example, remote user 1206 may provide an indication of an object in the environment of user 1202. For instance, remote user 1206 may select the object in image 1204 as displayed by remote user computing device 714. Remote user computing device 714 may transmit an indication of the object to XR system 704.

In some aspects, the remote computing device is configured to: display the image of the physical environment; receive a user input indicative of the object; and transmit the indication of the object to the XR device. For example, remote user computing device 714 may be configured to display image 1204, receive a user input indicative of the object, and transmit the indication of the object to XR system 704.

At block 1318, the computing device (or one or more components thereof) may receive, from a local device, information regarding the object. For example, XR system 704 may receive information regarding the object from a local device, such as store computing device 702, shelf sensors 706, store sensors 708, and/or cart sensors 710.

In some aspects, the computing device (or one or more components thereof) may query the local device for the information regarding the object. For example, after receiving an indication of the object, XR system 704 may query, store computing device 702 regarding the object.

In some aspects, the computing device (or one or more components thereof) may transmit an image of the object to the local device to query the local device for the information regarding the object. For example, XR system 704 may transmit an image of the object to store computing device 702.

In some aspects, the computing device (or one or more components thereof) may identify the object; and transmit an identifier of the object to the local device to query the local device for the information regarding the object. For example, XR system 704 may identify the object (e.g., based on image 1204) and transmit an identifier of the object to store computing device 702.

In some aspects, the computing device (or one or more components thereof) may transmit the indication of the object to the local device to query the local device for the information regarding the object. For example, transmit the identifier of the object to store computing device 702 as a query regarding the object.

In some aspects, the local device is configured to: determine that a user of the XR device is interacting with the object; and in response to determining that the user of the XR device is interacting with the object, transmit the information regarding the object to the XR device. For example, user 1202 may be configured to determine that user 1202 is interacting with the object (e.g., based on data from shelf sensors 706, store sensors 708, cart sensors 710, etc. Further, user 1202 may transmit the information regarding the object in response to determining that the user is interacting with the object.

In some aspects, the local device comprises at least one of: a radio-frequency identifier (RFID) reader; an electronic shelf label (ESL) reader; a camera; a microphone; or a pressure sensor. For example, shelf sensors 706, store sensors 708 and/or cart sensors 710 may be, or may include, an RFID reader, an ESL reader, a camera; a microphone; and/or a pressure sensor.

At block 1320, the computing device (or one or more components thereof) may display the information regarding the object at a display of the XR device. For example, XR system 704 may display the information regarding the object to user 1202.

In some aspects, the computing device (or one or more components thereof) may display virtual content anchored to the object in a view of a user of the XR device. For example, the computing device (or one or more components thereof) may anchor virtual content to the object in the view of user 1202.

In some aspects, the computing device (or one or more components thereof) may display the information regarding the object in a position relative to the object in a view of a user of the XR device. For example, XR system 704 may display the information regarding the object in the field of view of user 1202 in a position in the field of view relative to the object in the field of view.

In some examples, as noted previously, the methods described herein (e.g., operations 902 of FIG. 9, process 1300 of FIG. 13A process 1310 of FIG. 13B, and/or other methods described herein) can be performed, in whole or in part, by a computing device or apparatus. In one example, one or more of the methods can be performed by system 700 of FIG. 7, store computing device 702 of FIG. 7, XR system 704 of FIG. 7, user computing device 712 of FIG. 7, remote user computing device 714 of FIG. 7, or by another system or device. In another example, one or more of the methods (e.g., operations 902, process 1300, process 1310, and/or other methods described herein) can be performed, in whole or in part, by the computing-device architecture 1500 shown in FIG. 15. For instance, a computing device with the computing-device architecture 1500 shown in FIG. 15 can include, or be included in, the components of the system 700, store computing device 702, XR system 704, user computing device 712, and/or remote user computing device 714, and can implement the operations of operations 902, process 1300, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Operations 902, process 1300, process 1310, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, operations 902, process 1300, process 1310, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

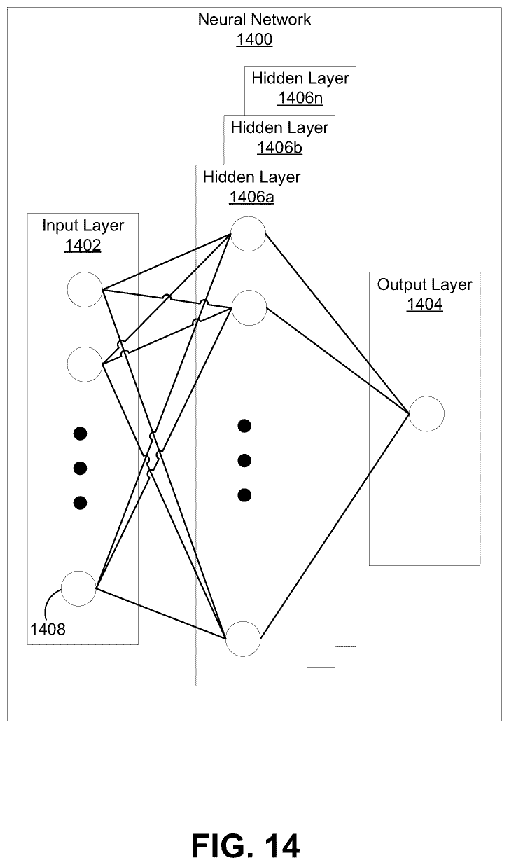

FIG. 14 is an illustrative example of a neural network 1400 (e.g., a deep-learning neural network) that can be used to implement machine-learning based object detection, object recognition, product recognition, label detection, gaze tracking, feature segmentation, implicit-neural-representation generation, rendering, classification, image recognition (e.g., face recognition, object recognition, scene recognition, etc.), feature extraction, authentication, gaze detection, gaze prediction, and/or automation.

An input layer 1402 includes input data. Neural network 1400 includes multiple hidden layers, for example, hidden layers 1406a, 1406b, through 1406n. The hidden layers 1406a, 1406b, through hidden layer 1406n include “n” number of hidden layers, where “n” is an integer greater than or equal to one. The number of hidden layers can be made to include as many layers as needed for the given application. Neural network 1400 further includes an output layer 1404 that provides an output resulting from the processing performed by the hidden layers 1406a, 1406b, through 1406n.

Neural network 1400 may be, or may include, a multi-layer neural network of interconnected nodes. Each node can represent a piece of information. Information associated with the nodes is shared among the different layers and each layer retains information as information is processed. In some cases, neural network 1400 can include a feed-forward network, in which case there are no feedback connections where outputs of the network are fed back into itself. In some cases, neural network 1400 can include a recurrent neural network, which can have loops that allow information to be carried across nodes while reading in input.

Information can be exchanged between nodes through node-to-node interconnections between the various layers. Nodes of input layer 1402 can activate a set of nodes in the first hidden layer 1406a. For example, as shown, each of the input nodes of input layer 1402 is connected to each of the nodes of the first hidden layer 1406a. The nodes of first hidden layer 1406a can transform the information of each input node by applying activation functions to the input node information. The information derived from the transformation can then be passed to and can activate the nodes of the next hidden layer 1406b, which can perform their own designated functions. Example functions include convolutional, up-sampling, data transformation, and/or any other suitable functions. The output of the hidden layer 1406b can then activate nodes of the next hidden layer, and so on. The output of the last hidden layer 1406n can activate one or more nodes of the output layer 1404, at which an output is provided. In some cases, while nodes (e.g., node 1408) in neural network 1400 are shown as having multiple output lines, a node has a single output and all lines shown as being output from a node represent the same output value.

In some cases, each node or interconnection between nodes can have a weight that is a set of parameters derived from the training of neural network 1400. Once neural network 1400 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1400 to be adaptive to inputs and able to learn as more and more data is processed.

Neural network 1400 may be pre-trained to process the features from the data in the input layer 1402 using the different hidden layers 1406a, 1406b, through 1406n in order to provide the output through the output layer 1404. In an example in which neural network 1400 is used to identify features in images, neural network 1400 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1400 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1400 is trained well enough so that the weights of the layers are accurately tuned.

For the example of identifying objects in images, the forward pass can include passing a training image through neural network 1400. The weights are initially randomized before neural network 1400 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1400, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1400 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1400 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 1400 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1400 can include any other deep network other than a CNN, such as an autoencoder, a deep belief nets (DBNs), a Recurrent Neural Networks (RNNs), among others.

FIG. 15 illustrates an example computing-device architecture 1500 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1500 may include, implement, or be included in any or all of system 700, store computing device 702, XR system 704, user computing device 712, remote user computing device 714, and/or other devices, modules, or systems described herein. Additionally or alternatively, computing-device architecture 1500 may be configured to perform operations 902, process 1300, process 1310, and/or other process described herein.

The components of computing-device architecture 1500 are shown in electrical communication with each other using connection 1512, such as a bus. The example computing-device architecture 1500 includes a processing unit (CPU or processor) 1502 and computing device connection 1512 that couples various computing device components including computing device memory 1510, such as read only memory (ROM) 1508 and random-access memory (RAM) 1506, to processor 1502.

Computing-device architecture 1500 can include a cache of high-speed memory connected directly with, in close proximity to, or integrated as part of processor 1502. Computing-device architecture 1500 can copy data from memory 1510 and/or the storage device 1514 to cache 1504 for quick access by processor 1502. In this way, the cache can provide a performance boost that avoids processor 1502 delays while waiting for data. These and other modules can control or be configured to control processor 1502 to perform various actions. Other computing device memory 1510 may be available for use as well. Memory 1510 can include multiple different types of memory with different performance characteristics. Processor 1502 can include any general-purpose processor and a hardware or software service, such as service 1 1516, service 2 1518, and service 3 1520 stored in storage device 1514, configured to control processor 1502 as well as a special-purpose processor where software instructions are incorporated into the processor design. Processor 1502 may be a self-contained system, containing multiple cores or processors, a bus, memory controller, cache, etc. A multi-core processor may be symmetric or asymmetric.

To enable user interaction with the computing-device architecture 1500, input device 1522 can represent any number of input mechanisms, such as a microphone for speech, a touch-sensitive screen for gesture or graphical input, keyboard, mouse, motion input, speech and so forth. Output device 1524 can also be one or more of a number of output mechanisms known to those of skill in the art, such as a display, projector, television, speaker device, etc. In some instances, multimodal computing devices can enable a user to provide multiple types of input to communicate with computing-device architecture 1500. Communication interface 1526 can generally govern and manage the user input and computing device output. There is no restriction on operating on any particular hardware arrangement and therefore the basic features here may easily be substituted for improved hardware or firmware arrangements as they are developed.

Storage device 1514 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1506, read only memory (ROM) 1508, and hybrids thereof. Storage device 1514 can include services 1516, 1518, and 1520 for controlling processor 1502. Other hardware or software modules are contemplated. Storage device 1514 can be connected to the computing device connection 1512. In one aspect, a hardware module that performs a particular function can include the software component stored in a computer-readable medium in connection with the necessary hardware components, such as processor 1502, connection 1512, output device 1524, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for extended reality (XR), the apparatus comprising: at least one memory; and at least one processor coupled to the at least one memory and configured to: capture an image of a physical environment using a camera of an extended-reality (XR) device in the physical environment; transmit the image to a remote computing device; receive, from the remote computing device, an indication of an object in the physical environment; receive, from a local device, information regarding the object; and display the information regarding the object at a display of the XR device.
Aspect 2. The apparatus of aspect 1, wherein the at least one processor is configured to query the local device for the information regarding the object.
Aspect 3. The apparatus of aspect 2, wherein the at least one processor is configured to transmit an image of the object to the local device to query the local device for the information regarding the object.
Aspect 4. The apparatus of any one of aspects 2 or 3 wherein the at least one processor is configured to: identify the object; and transmit an identifier of the object to the local device to query the local device for the information regarding the object.
Aspect 5. The apparatus of any one of aspects 2 to 4, wherein the at least one processor is configured to transmit the indication of the object to the local device to query the local device for the information regarding the object.
Aspect 6. The apparatus of any one of aspects 1 to 5, wherein the at least one processor is configured to display virtual content anchored to the object in a view of a user of the XR device.
Aspect 7. The apparatus of any one of aspects 1 to 6, wherein the at least one processor is configured to display the information regarding the object in a position relative to the object in a view of a user of the XR device.
Aspect 8. The apparatus of any one of aspects 1 to 7, wherein the local device is configured to: determine that a user of the XR device is interacting with the object; and in response to determining that the user of the XR device is interacting with the object, transmit the information regarding the object to the XR device.
Aspect 9. The apparatus of any one of aspects 1 to 8, wherein the local device comprises at least one of: a radio-frequency identifier (RFID) reader; an electronic shelf label (ESL) reader; a camera; a microphone; or a pressure sensor.
Aspect 10. The apparatus of any one of aspects 1 to 9, wherein the remote computing device is configured to: display the image of the physical environment; receive a user input indicative of the object; and transmit the indication of the object to the XR device.
Aspect 11. A method for extended reality (XR), the method comprising: capturing an image of a physical environment using a camera of an extended-reality (XR) device in the physical environment; transmitting the image to a remote computing device; receiving, from the remote computing device, an indication of an object in the physical environment; receiving, from a local device, information regarding the object; and displaying the information regarding the object at a display of the XR device.
Aspect 12. The method of aspect 11, further comprising querying the local device for the information regarding the object.
Aspect 13. The method of aspect 12, further comprising transmitting an image of the object to the local device to query the local device for the information regarding the object.
Aspect 14. The method of any one of aspects 12 or 13, further comprising: identifying the object; and transmitting an identifier of the object to the local device to query the local device for the information regarding the object.
Aspect 15. The method of any one of aspects 12 to 14, further comprising transmitting the indication of the object to the local device to query the local device for the information regarding the object.
Aspect 16. The method of any one of aspects 11 to 15, further comprising displaying virtual content anchored to the object in a view of a user of the XR device.
Aspect 17. The method of any one of aspects 11 to 16, further comprising displaying the information regarding the object in a position relative to the object in a view of a user of the XR device.
Aspect 18. The method of any one of aspects 11 to 17, wherein the local device is configured to: determine that a user of the XR device is interacting with the object; and in response to determining that the user of the XR device is interacting with the object, transmit the information regarding the object to the XR device.
Aspect 19. The method of any one of aspects 11 to 18, wherein the local device comprises at least one of: a radio-frequency identifier (RFID) reader; an electronic shelf label (ESL) reader; a camera; a microphone; or a pressure sensor.
Aspect 20. The method of any one of aspects 11 to 19, wherein the remote computing device is configured to: display the image of the physical environment; receive a user input indicative of the object; and transmit the indication of the object to the XR device.
Aspect 21. A non-transitory computer-readable storage medium having stored thereon instructions that, when executed by at least one processor, cause the at least one processor to perform operations according to any of aspects 11 to 20.
Aspect 22. An apparatus for extended reality, the apparatus comprising one or more means for perform operations according to any of aspects 11 to 20.

What is claimed is:

1. An apparatus for extended reality (XR), the apparatus comprising:
at least one memory; and
at least one processor coupled to the at least one memory and configured to:
capture an image of a physical environment using a camera of an extended-reality (XR) device in the physical environment;
transmit the image to a remote computing device;
receive, from the remote computing device, an indication of an object in the physical environment;
receive, from a local device, information regarding the object; and
display the information regarding the object at a display of the XR device.

2. The apparatus of claim 1, wherein the at least one processor is configured to query the local device for the information regarding the object.

3. The apparatus of claim 2, wherein the at least one processor is configured to transmit an image of the object to the local device to query the local device for the information regarding the object.

4. The apparatus of claim 2, wherein the at least one processor is configured to:
identify the object; and
transmit an identifier of the object to the local device to query the local device for the information regarding the object.

5. The apparatus of claim 2, wherein the at least one processor is configured to transmit the indication of the object to the local device to query the local device for the information regarding the object.

6. The apparatus of claim 1, wherein the at least one processor is configured to display virtual content anchored to the object in a view of a user of the XR device.

7. The apparatus of claim 1, wherein the at least one processor is configured to display the information regarding the object in a position relative to the object in a view of a user of the XR device.

8. The apparatus of claim 1, wherein the local device is configured to:
determine that a user of the XR device is interacting with the object; and
in response to determining that the user of the XR device is interacting with the object, transmit the information regarding the object to the XR device.

9. The apparatus of claim 1, wherein the local device comprises at least one of:
a radio-frequency identifier (RFID) reader;
an electronic shelf label (ESL) reader;
a camera;
a microphone; or
a pressure sensor.

10. The apparatus of claim 1, wherein the remote computing device is configured to:
display the image of the physical environment;
receive a user input indicative of the object; and
transmit the indication of the object to the XR device.

11. A method for extended reality (XR), the method comprising:
capturing an image of a physical environment using a camera of an extended-reality (XR) device in the physical environment;
transmitting the image to a remote computing device;
receiving, from the remote computing device, an indication of an object in the physical environment;
receiving, from a local device, information regarding the object; and
displaying the information regarding the object at a display of the XR device.

12. The method of claim 11, further comprising querying the local device for the information regarding the object.

13. The method of claim 12, further comprising transmitting an image of the object to the local device to query the local device for the information regarding the object.

14. The method of claim 12, further comprising:
identifying the object; and
transmitting an identifier of the object to the local device to query the local device for the information regarding the object.

15. The method of claim 12, further comprising transmitting the indication of the object to the local device to query the local device for the information regarding the object.

16. The method of claim 11, further comprising displaying virtual content anchored to the object in a view of a user of the XR device.

17. The method of claim 11, further comprising displaying the information regarding the object in a position relative to the object in a view of a user of the XR device.

18. The method of claim 11, wherein the local device is configured to:
determine that a user of the XR device is interacting with the object; and
in response to determining that the user of the XR device is interacting with the object, transmit the information regarding the object to the XR device.

19. The method of claim 11, wherein the local device comprises at least one of:
a radio-frequency identifier (RFID) reader;
an electronic shelf label (ESL) reader;
a camera;
a microphone; or
a pressure sensor.

20. The method of claim 11, wherein the remote computing device is configured to:
display the image of the physical environment;
receive a user input indicative of the object; and
transmit the indication of the object to the XR device.
